(19) United States
(12) Patent Application Publication
(10) Pub. No.: US 2024/0241687 A1
(43) Pub. Date: Jul. 18, 2024

(54) Automatic Adjustment of Audio Playback Rates

(71) Applicant: Google LLC, Mountain View, CA (US)

(72) Inventors: Dara Gruber, Seattle, WA (US); Christopher Michael Poole, New York, NY (US)

(21) Appl. No.: 18/010,174

(22) PCT Filed: Aug. 31, 2021
(86) PCT No.: PCT/US2021/048385

§ 371 Date: Mar. 9, 2023

(51) Int. Cl. G06F 3/16; G06F 40/30; H04L 67/306

(52) U.S. Cl. CPC G06F 3/165; G06F 40/30; H04L 67/306

(57) ABSTRACT

Methods, systems, devices, and tangible non-transitory computer readable media for adaptive adjustment of playback. The disclosed technology can include accessing content data that includes one or more portions of content for a user. One or more content complexities of the one or more portions of content can be determined. One or more content relevancies of the one or more portions of content can be determined. One or more playback rates can be determined. The one or more playback rates can be based at least in part on the one or more content complexities or the one or more content relevancies. Furthermore, output associated with playback of the one or more portions of content can be generated at the one or more playback rates.

### FIELD

The present disclosure relates generally to processing audio content. More particularly, the present disclosure relates to the use of computing systems to automatically adjust the play back rate of audio content.

### BACKGROUND

Various types of devices and applications can be used to facilitate user understanding of content. Further, these devices and applications may capture information from different sources and is then provided to the user in a variety of forms. For example, audio content can be provided to the user. Providing this information in a manner that is efficiently comprehensible to the user may entail modifying the source content.

However, modification of the source content may introduce further obstacles to the user's understanding of the content. For example, the content may be presented too quickly for the user to properly grasp it. Further, though the user may comprehend certain portions of content when the content is presented at a particular rate, other portions of that content may be better understood when presented at a different rate. For example, increasing or decreasing the speed of audio playback may improve a user's comprehension of audio content. However, such adjustments are often performed in a generalized manner in which the speed of the content as a whole is increased or decreased. As a result, such adjustments do not selectively adjust the speed of selected portions of the content. As such, there exists a demand for more effective ways of adjusting the rate at which content is played back.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method of adaptively adjusting a playback rate of content. The computer-implemented method can include accessing, by a computing device comprising one or more processors, content data comprising one or more portions of content for a user. The computer-implemented method can include determining, by the computing device, one or more content relevancies of the one or more portions of content. The computer-implemented method can include determining, by the computing device, one or more playback rates. The one or more playback rates can be based at least in part on the one or more content relevancies. Furthermore, the computer-implemented method can include generating, by the computing device, output associated with playback of the one or more portions of content at the one or more play back rates.

Another example aspect of the present disclosure is directed to one or more tangible non-transitory computer-readable media storing computer-readable instructions that when executed by one or more processors cause the one or more processors to perform operations. The operations can include accessing content data comprising one or more portions of content for a user. The operations can also include determining one or more content relevancies of the one or more portions of content. The operations can include determining one or more playback rates. The one or more playback rates can be based at least in part on the one or more content relevancies. Furthermore, the operations can include generating output associated with playback of the one or more portions of content at the one or more play back rates.

Another example aspect of the present disclosure is directed to a computing system comprising: one or more processors: one or more non-transitory computer-readable media storing instructions that when executed by the one or more processors cause the one or more processors to perform operations. The operations can include accessing content data comprising one or more portions of content for a user. The operations can also include determining one or more content complexities of the one or more portions of content. The operations can include determining one or more playback rates. The one or more play back rates can be based at least in part on the one or more content complexities. Furthermore, the operations can include generating output associated with play back of the one or more portions of content at the one or more play back rates.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A depicts a block diagram of an example computing system that performs operations associated with adaptive adjustment of play back according to example embodiments of the present disclosure.

FIG. 1B depicts a block diagram of an example of a computing device that performs operations associated with adaptive adjustment of play back according to example embodiments of the present disclosure.

FIG. 1C depicts a block diagram of an example computing device that performs operations associated with adaptive adjustment of play back according to example embodiments of the present disclosure.

FIG. 2 depicts a block diagram of an example of one or more machine-learned models according to example embodiments of the present disclosure.

FIG. 3 depicts an example of an example computing device according to example embodiments of the present disclosure.

FIG. 4 depicts an example of adaptive adjustment of playback according to example embodiments of the present disclosure.

FIG. 5 depicts an example of adaptive adjustment of playback according to example embodiments of the present disclosure.

FIG. 6 depicts an example of adaptive adjustment of playback according to example embodiments of the present disclosure.

FIG. 7 depicts an example of adaptive adjustment of play back according to example embodiments of the present disclosure.

FIG. 8 depicts a flow diagram of adaptive adjustment of play back according to example embodiments of the present disclosure.

FIG. 9 depicts a flow diagram of adaptive adjustment of playback according to example embodiments of the present disclosure.

FIG. 10 depicts a flow diagram of adaptive adjustment of play back according to example embodiments of the present disclosure.

FIG. 11 depicts a flow diagram of adaptive adjustment of play back according to example embodiments of the present disclosure.

FIG. 12 depicts a flow diagram of adaptive adjustment of play back according to example embodiments of the present disclosure.

Reference numerals that are repeated across plural figures are intended to identify the same features in various implementations.

### DETAILED DESCRIPTION

Example aspects of the present disclosure are directed to a computing system that can adaptively adjust a playback rate of content. In particular, the disclosed technology can generate auditory output of content that is played back at a rate based on the complexity, relevance, and/or semantic structure of portions of the content. Further, the disclosed technology can leverage the use of machine-learned models that have been trained to extract useful semantic and contextual information relating to the complexity and relevance of content that is provided to a user at an optimized rate of play back.

By way of example, a user may wish to listen to an audio recording of the news in a manner that minimizes the play back duration while maintaining an acceptable level of comprehensibility of the content. One way to do this is for the user to manually adjust the play back speed as the audio content is being played, however, this requires significant manual intervention from the user and is burdensome. Additionally, without knowing the complexity and/or relevance of the content that is being played, the play back speed of the content will be based on content the user has not yet heard, meaning that the selected play back rate may not be appropriate (e.g., the play back rate may be too fast or too slow).

To relieve the user of the burden of manually adjusting the play back rate of content, the disclosed technology can automatically determine an appropriate play back rate for the each portion of the content. To do this, a computing system of the disclosed technology can parse the content data associated with the news and determine the respective complexities, relevancies, and semantic structure of each portion of an audio recording (e.g., each portion may include a snippet of the audio recording that may be of equal or varying duration). Based on an analysis of the audio recording, the computing system can determine optimized play back rates for each portion of the content so that when the content is played back, the playback rate will be within a range that corresponds to the complexity, relevance, and semantic structure of each portion of content. Further, because the play back rate of the content can be varied on a continuous basis over the course of play back, the user is not restricted to a single faster or slower playback rate. Instead, an appropriate play back rate is determined for each portion of the content, so that come simpler or less relevant portions may be played back at a higher rate and more complex or relevant portions may be played back at a slower rate.

Further, the disclosed technology can request feedback from the user, via a user interface, that can be used to further optimize the rate of playback based on the user's inputs (e.g., the play back was too fast or too slow). As such, the disclosed technology allows for improved playback of audio that is based on content complexity, content relevance, and/or semantic structure. Further, the playback rate can be further personalized to meet an individual user's requirements based on a user profile and/or user interactions during play back of the content. As such, the disclosed technology allows a user to process audio content more effectively.

The one or more playback rates can be determined on-device and/or remotely (e.g., on a remote server computing device) and can adjust the play back rate based on user interactions with the content as the content is being played. For example, when the user increases and/or decreases the playback rate, the disclosed technology can determine a relationship between the user determined playback rate and the complexity, relevance, and/or semantic structure of the corresponding portion of the content. The disclosed technology can then adjust a machine-learning model or some set of heuristics so that future playback of similar portions of content is played back at a more optimal playback rate.

A computing system of the disclosed technology can access content data that includes one or more portions of content for a user. For example, the computing system can access content data stored on a remote computing system of a news provider that provides content data including audio recording of news programs. The disclosed technology can then segment the content data into one or more portions of content that can be analyzed to determine the respective complexity and relevance of each portion.

For example, the content data can be used as an input to a machine-learned model that is configured and/or trained to determine one or more content complexities and one or more content relevancies of the one or more portions of content. The complexity and/or relevance can be based on a generic model (e.g., one standard model that determines the complexity and/or relevance of content) or an individualized model that determines the complexity and relevance of a portion of content based on the complexity and relevance profiles of an individual user. Based on the determined complexity and relevance of each portion of content, the disclosed technology can determine one or more playback rates for each respective portion of content. Further, the playback rates can vary as the content is played back and can for example, slow down for more complex content and speed up for less relevant content when output of the content data is generated. The generated output can include a continuous stream of the audio in which each portion of the content is played back at the determined play back rate and without the need for user intervention.

Accordingly, the disclosed technology can improve the user experience by providing the user with audio content that is played back at an optimized rate. Further, the disclosed technology can assist a user in more effectively performing the technical task of audio playback by means of a continued and/or guided human-machine interaction process in which content data is received and the disclosed technology automatically generates output audio at an appropriate play back rate.

The computing system can access, receive, obtain, and/or retrieve data which can include content data. The content data can include one or more portions of content for a user. The content data can be associated with any type of content and may include one or more words (e.g., spoken words or text). Further, the content data can include metadata indicating the subject matter of the one or more portions of content, the length (e.g., duration and/or number of words) of the one or more portions of content, and/or a bit rate of the content data. In some embodiments, the content data may include information associated with the complexity of one or more portions of content. For example, the content data may indicate that content from a scientific document is highly complex.

In some embodiments, the content data can include audio data associated with auditory content and/or textual data associated with textual content. By way of example, the content data can include recorded audio (e.g., streaming audio, a podcast, an audio interview, and/or a video interview) that may be stored on the computing system (e.g., locally stored audio) or accessed from a remote computing system (e.g., streaming audio). By way of further example, the textual content can include textual information that may be accessed by the computing system and used to generate auditory output that includes a synthetic voice that reads the textual content at the one or more playback rates.

The computing system can determine one or more content complexities of the one or more portions of content. For example, the computing system can analyze the one or more portions of content and determine the complexity of each of the one or more portions of content individually and/or in relation to one or more other portions of content. Further, the computing can assign a complexity value (e.g., a numeric value) to each of the one or more portions of content. For example, a higher complexity value may correspond to a higher complexity of a portion of content (e.g., a portion of content that includes complex words, complex sentence structure, and includes nuanced language in which certain the meaning may be ambiguous). Further, a lower complexity value may correspond to a lower complexity portion of content (e.g., a portion of content that includes simpler words, simpler sentence structure, and uses language with clear and unambiguous meaning).

In some embodiments, determination of the one or more content complexities can be based at least in part on the use of one or more machine-learned models. For example, the computing system can perform one or more operations including using the content data (e.g., the one or more portions of content) as part of an input to one or more machine-learned models that are configured and/or trained to access the input, perform one or more operations on the input, and generate an output including the one or more content complexities. The one or more content complexities can be associated with a complexity of the one or more portions of content. The complexity of a portion of content can be based at least in part on one or more complexity factors including word length, a tagged word complexity value (e.g., a dictionary of words in which each word is associated with a respective complexity value), the number of syllables in each word, and/or the number of words in a portion of content (e.g., the number of words in a phrase and/or sentence).

The computing system can determine one or more content relevancies of the one or more portions of content. For example, the computing system can analyze the one or more portions of content and determine the relevance of each of the one or more portions of content individually and/or in relation to one or more other portions of content. Further, the computing can assign a content relevance value (e.g., a numeric value) to each of the one or more portions of content (e.g., one or more words and/or one or more phrases). For example, a higher content relevance value may correspond to a higher relevance of a portion of content (e.g., a portion of content that is relevant to some set of predetermined relevant content associated with a user). Further, a lower content relevance value may correspond to a lower relevance portion of content (e.g., a portion of content that is not relevant to some set of predetermined relevant content associated with a user). The relevance of content may be based at least in part on comparison of a portion of content to other portions of content to determine whether the portion of content is relevant to the other content or may be a digression that can be played back at a higher rate. In some embodiments, determining the one or more content relevancies of the one or more portions of content can include identifying one or more portions of content that match one or more words and/or one or more phrases of the content relevance profile. In some embodiments, a phrase can include a single word (e.g., the phrase “STOP”). Further, determining the one or more content relevancies of the one or more portions of content can include determining at least one of the one or more content relevancies of the one or more portions of content based at least in part on the content relevance values assigned to the one or more words and/or one or more phrases that match. For example, a portion of content with one or more words that are highly relevant to the content can have correspondingly high content relevance values, which can be combined to indicate that the portion of content is highly relevant. By way of further example, a portion of content with one or more phrases that have low relevance with respect to the content can have correspondingly low content relevance values, which can be combined to indicate that the portion of content has low relevance.

In some embodiments, determination of the one or more content complexities can be based at least in part on the use of one or more machine-learned models. For example, the computing system can perform one or more operations including using the content data (e.g., the one or more portions of content) as part of an input to one or more machine-learned models that are configured and/or trained to access the input, perform one or more operations on the input, and generate an output including the one or more content relevancies. The one or more content relevancies can be associated with a relevance of each of the one or more portions of content. The relevance of a portion of content can be based at least in part on one or more relevance factors including the extent to which a portion of content corresponds to other portions of content and/or to user defined criteria of relevance (e.g., subject matter that is relevant to the user and/or the set of topics in the one or more portions of content). For example, relevant content can include one or more portions of content that are more associated with one or more other portions of content and that is less associated with one or more exemplary portions of content that are determined to be less relevant (e.g., pauses in conversation, moments of silence, a speaker clearing their throat or coughing, and/or speech disfluencies or fillers including “uhm” or “ah”). Further, the relevance of a portion of content can be based at least in part on a relevancy value that is associated with an analysis of the portion of content. Analysis of the portion of content to determine a relevancy value can include a comparison of each word in a portion of content to one or more other words in the content as a whole, whether words in a portion of content are associated with the overarching subject matter of the content as a whole, and/or whether words in a portion of content are keywords for the type of content (e.g., words like “apex” or the name of a particular mountain (Mount Everest) are more relevant in the context of content related to mountains than words as “the” or “a”). Further, in some embodiments, the complexity of words can be based at least in part on a complexity dictionary in which words for particular subject matter have a corresponding value (e.g., more complex words have higher values than less complex words). Further, different types of content can have different respective complexity dictionaries (e.g., a complexity dictionary for subject matter related to politics may have a different set of complexity values from a complexity dictionary for subject matter related to engineering).

The computing system can determine one or more playback rates. The one or more playback rates can be based at least in part on the one or more content complexities and/or the one or more content relevancies. For example, the playback rate for a portion of the content can be increased when the complexity of that portion is low and the play back rate for a portion of the content can be decreased when the complexity of that portion is high. Further, the play back rate for a portion of the content can be increased when the relevancy of that portion is low and the playback rate for a portion of the content can be decreased when the relevancy of that portion is high. Further, the one or more playback rates can be associated with and/or correspond to one or more playback speeds, one or more playback velocities, one or more syllables per second, one or more words per second, and/or one more sentences per minute. Furthermore, the one or more playback rates can be based at least in part on any combination of the one or more content complexities and/or the one or more content relevancies. For example, the one or more playback rates can be based at least in part on only the one or more content complexities, only the one or more content relevancies, or both the one or more content complexities and the one or more content relevancies.

In some embodiments, the one or more playback rates can be based at least in part on the one or more content complexities to the exclusion of the one or more content relevancies. For example, the one or more portions of content that are highly complex may be determined to have a lower playback rate without regard for the relevance of the portion of content.

In some embodiments, the one or more playback rates can be based at least in part on the one or more content relevancies to the exclusion of the one or more content complexities. For example, the one or more portions of content that are highly relevant may be determined to have a lower play back rate without regard for the complexity of the portion of content.

The computing system can determine the play back rate for a portion of the content based at least in part on some combination of the content complexity and/or content relevancy of that portion of content. For example, the computing system can analyze the one or more content complexities and/or the one or more content relevancies to determine the play back rate of each of the one or more portions of content. In some embodiments, the one or more complexities and/or the one or more content relevancies in each of the one or more portions of content can be associated with one or more content complexity values and/or one or more content relevancy values. Based at least in part on the one or more content complexity values and/or one or more content relevancy values associate with each of the one or more portions of content, the computing system can determine each of the one or more respective playback rates. For example, the one or more play back rates can be based at least in part on a weighted combination of the one or more content complexity values and/or one or more content relevancy values (e.g., equal weighting or a weighting in which content complexity values and/or content relevancy values are weighted more heavily). The one or more playback rates can be increased when a portion of content is less relevant (e.g., the play back speed is increased) and decreased when a portion of content is less relevant (e.g., the playback speed is decreased). The one or more playback rates can be decreased when a portion of content is more complex and increased when the portion of content is less complex. In some embodiments, the weighting of the one or more content relevancy values are more heavily weighted than the one or more content complexity values, such that any portion of content that is not relevant (e.g., the relevancy value does not exceed a relevancy threshold) is played back at a higher rate.

In some embodiments, determination of the one or more content playback rates can be based at least in part on the use of one or more machine-learned models. For example, the computing system can perform one or more operations including using the content data (e.g., the one or more portions of content), the one or more content complexities, and/or the one or more content relevancies, as part of an input to one or more machine-learned models that are configured and/or trained to access the input, perform one or more operations on the input, and generate an output including the one or more content playback rates. The one or more content playback rates can be associated with a playback rate of the one or more portions of content.

In some embodiments, the one or more machine-learned models can be configured and/or trained to access input comprising the content data, perform one or more operations, and generate output including any combination of the one or more complexities, one or more relevancies, and/or one or more play back speeds.

The computing system can generate output. The output can be associated with play back of the one or more portions of content. Further, output can be associated with play back of the one or more portions of content at the one or more playback rates. For example, the output can include audio output. Further, the audio output can be based at least in part on the one or more portions of content which are played back at the one or more play back rates. The audio output can include one or more indications respectively associated with the one or more portions of content. Further, the one or more indications can be played back at the one or more playback rates (e.g., the one or more indications can include one or more indications played back at the same playback rate as the one or more portions of content, one or more indications played back at a higher playback rate than the one or more portions of content, and/or one or more indications played back at a lower playback rate than the one or more portions of content).

In some embodiments, the output can include one or more indications associated with the one or more portions of content. Further, the one or more indications can be based at least in part on the one or more playback rates. For example, the computing system can generate audio output via one or more loudspeakers. The audio output can include the one or more portions of content being played back at the respective one or more playback rates (e.g., one or more play back speeds). In some embodiments, the computing system can perform one or more operations on the output to maintain an auditory pitch within a predetermined set of pitch parameters. In this way the output can maintain a high level of clarity even at high play back rates.

In some embodiments, the one or more indications can include one or more visual indications and/or one or more aural indications. The one or more indications can include one or more aural indications and/or one or more visual indications. The one or more aural indications can include recorded audio content that is output (e.g., played back via an audio output component) at the one or more playback rates. The output (e.g., the audio content) can be adjusted to ensure that the pitch is within a predetermined range that is not too high or too low. In some embodiments, the one or more indications can include a synthetic voice that is generated based on the content data. For example, the one or more aural indications can include a synthetic voice that reads the one or more portions of content to the user of a computing device via an audio output component (e.g., loud speaker) of the computing system.

The one or more visual indications can include any combination of text and/or pictures (e.g., still images and/or video images) that are displayed on a display device of the computing system in order to represent the one or more portions of content data. For example, the one or more visual indications can include a textual representation (e.g., a transcript) of audio content that is being played back by the computing system.

The computing system can receive one or more inputs to a user interface. The one or more inputs can be associated with setting one or more thresholds for the one or more playback rates. For example, the one or more inputs can include one or more inputs to set a maximum playback rate and/or a minimum play back rate. Further, the one or more inputs can include one or more inputs to increase and/or decrease the play back rate of content that is being played. For example, the user can provide one or more inputs to increase and/or decrease the playback rate of content while the content is being played.

The computing system can determine the one or more playback rates based at least in part on the one or more inputs associated with setting the one or more thresholds for the one or more playback rates. For example, the computing system can determine that the one or more playback rates do not fall below a minimum playback rate threshold or exceed a maximum playback rate threshold.

In some embodiments, the one or more thresholds for the one or more play back rates can include a minimum playback rate and/or a maximum play back rate. For example, the minimum playback rate can define a minimum playback rate in words per second, below which the play back rate will not fall. By way of further example, the maximum play back rate can define a maximum playback rate in words per second, above which the one or more portions of content will not be played back.

In some embodiments, the one or more content complexities can be based at least in part on a content complexity profile associated with the user. The content complexity profile can be associated with one or more respective user comprehension levels of one or more types of content. For example, the content complexity profile can include a record of the words for which a user has previously increased or decreased the playback rate. Further and/or alternatively, the content complexity profile can include a baseline complexity for a user based at least in part on a combination of an average playback rate for multiple users and/or previous play back rates of an individual user including playback rates during a current playback session. The content complexity profile can include different playback speeds for different types of content.

In some embodiments, the one or more content relevancies can be based at least in part on a content relevance profile associated with the user. For example, the determination of the relevance of each of the one or more portions of content can use the content relevance profile of the user that is playing the content. Further, the content relevance profile is associated with one or more types of content that are relevant to the user. For example, types of content associated with subject matter that has been flagged as particularly important to a user may have an increased content relevance.

In some embodiments, determining the one or more content complexities of the one or more portions of content and/or determining the one or more content relevancies of the one or more portions of content can include determining one or more words in the one or more portions of content. For example, the computing system can use one or more speech processing techniques to determine one or more words associated with each of the one or more portions of content.

Further, the determining the one or more content complexities of the one or more portions of content and/or determining the one or more content relevancies of the one or more portions of content can include determining a semantic structure of the one or more words. The semantic structure is based at least in part on one or more respective complexities of the one or more words, a respective relevance of each of the one or more words, an arrangement of the one or more words, and/or a semantic context of each of the one or more words. For example, the computing system can determine a type of each word (e.g., noun, verb, adjective, or article), the arrangement (e.g., word order) of the words, sentence length, grammatical structure, and other attributes of the one or more portions of content. In some embodiments, the one or more content complexities can be based at least in part on the semantic structure of the one or more words. For example, different semantic structures can be associated with different levels of content complexity.

The computing system can determine the one or more portions of content that are associated with one or more previous portions of content. For example, the computing system can compare each of the one or more portions of content to each of the one or more previous portions of content that preceded that portion. The comparison can determine whether the one or more portions of content include similar words or other semantic content that is similar to the one or more previous portions of content. In some embodiments, determining the one or more portions of content that are associated with one or more previous portions of content can include determining a number of words in the one or more previous portions of content that are repeated in the one or more portions of content. For example, the computing system can analyze each word in the content and determine whether and/or how many times each word is repeated in the entire content.

The computing system can adjust the one or more playback rates of the one or more portions of content that are associated with one or more previous portions of content. Adjusting the one or more playback rates can include increasing the play back rate of the one or more portions of content that are associated with one or more previous portions of content. For example, the computing system can analyze each portion of content to determine a degree of similarity with one or more previous portions of content. The computing system can then adjust the one or more playback rates based at least in part on the degree of similarity (e.g., a greater degree of similarity can result in a greater increase in the play back rate).

In some embodiments, the one or more playback rates can be cumulatively adjusted based at least in part on an amount of the one or more previous portions of content. For example, the playback rate of a portion of content can be cumulatively increased each time the same or similar content is repeated within some threshold amount of time. By way of further example, the playback rate of a portion of content can be cumulatively decreased when the same or similar type of content has not been repeated for some threshold amount of time.

The determination of the one or more content complexities or the one or more content relevancies can be based at least in part on use of one or more machine-learned models. Further, the one or more machine-learned models can be configured to receive input that can include the content data, perform one or more operations on the content data, and generate output that can include the one or more content complexities and/or the one or more content relevancies. Training the one or more machine-learned models can include using user feedback and other training data as part of a training input to the one or more machine-learned models. For example, the training data can include sets of content data (e.g., audio recordings and/or transcripts of the audio recording) that include one or more portions of content that may be tagged with the respective complexity and/or relevancy of each of the one or more portions of content. A loss function can then be used to generate a loss and the weighting of the parameters of the loss function can be adjusted to minimize the loss over a plurality of iterations. The training input to the one or more machine learned models can also include information associated with the content data, the one or more content complexities, the one or more content relevancies, and/or the one or more playback rates. Based at least in part on the training input, the one or more machine-learned models can perform one or more operations and generate an output including one or more playback rates that have been optimized to emphasize relevant and complex (and in some cases relevant and non-complex) portions of content and deemphasize irrelevant portions of content.

Over a plurality of iterations, a weighting of one or more parameters of the one or more machine-learned models can be adjusted based at least in part on user feedback, supervised learning sessions, and/or unsupervised learning sessions. For example, positive user feedback that confirms that a playback rate is appropriate can result in greater weighting of the one or more parameters associated with that playback rate for the associated portion of content and/or similar portions of content. By way of further example, negative user feedback indicating that the play back rate is too fast or too slow can result in a lower weighting of the one or more parameters associated with the form and type of content in the associated portion of content. As a result, the one or more machine-learned models may generate more effective playback rates over time as the one or more machine-learned models are configured and/or trained using the user's feedback and other training inputs.

In some embodiments, the one or more machine-learned models can be configured to determine the one or more content complexities and/or the one or more content relevancies based at least in part on use of one or more natural language processing techniques. Further, the one or more natural language processing techniques can include one or more sentiment analysis techniques and/or one or more context analysis techniques.

In some embodiments, the output can include a request for feedback from the user with respect to the one or more playback rates. For example, the computing system can generate one or more aural indications requesting that the user “PROVIDE FEEDBACK ON THE PLAYBACK RATE OF THE CONTENT THAT WAS JUST PROVIDED.”

The computing system can access, receive, obtain, and/or retrieve the feedback from the user. The feedback from the user can be accessed, received, obtained, and/or retrieved via a user interface of the computing system. For example, after generating output that includes one or more aural indications or one or more visual indications requesting feedback from the user, the computing system can receive the user's feedback (e.g., a spoken response by the user or a tactile user interaction with a user interface of the computing system).

The computing system can perform one or more operations based at least in part on and/or associated with the output. The operations can be based at least in part on the feedback from the user. The one or more operations associated with the output can include adjusting a user profile of the user based at least in part on the feedback. For example, the computing system can modify the user profile by adding, removing, or changing data stored in the user profile. The user profile can include information and/or data associated with a user preferred playback rate. For example, based on previous user interactions (e.g., increasing or decreasing the playback rate of content) with content data being played back and/or interactions with content currently being played back, the user profile can be adjusted to indicate the preferred speed of the portion of content and/or the related complexity, relevance, and/or semantic structure of the portions of content that were adjusted by the user. Further, subsequent output associated with playback of the one or more portions of content and/or the one or more playback rates can be based at least in part on the user profile. For example, content that includes a similar content, relevance, and/or semantic structure can be played back at a playback rate in accordance with the user profile.

In some embodiments, the one or more playback rates can be negatively correlated with the one or more content complexities. For example, each of the one or more content complexities can be associated with a value (e.g., a numeric value) in which a higher value is associated with a greater complexity and a lower value is associated with a lower complexity (e.g., on a scale ranging from zero (0)) to ten (10), a value of zero (0)) can indicate the lowest complexity and a value of ten (10) can indicate the highest complexity). A portion of content associated with a higher complexity can have a relatively higher value and a correspondingly lower play back rate (e.g., playback at a lesser rate of speed) than a portion of content associated with a lower complexity which would have a higher playback rate.

In some embodiments, the one or more play back rates can be negatively correlated with the one or more content relevancies. For example, each of the one or more content relevancies can be associated with a value (e.g., a numeric value) in which a higher value is associated with a higher relevance and a lower value is associated with a lower relevance (e.g., on a scale ranging from zero (0)) to ten (10), a value of zero (0)) can indicate the lowest relevance and a value of ten (10) can indicate the highest relevance). A portion of content associated with a higher relevance can have a relatively higher value and a lower playback rate (e.g., playback at a lower rate of speed) than a portion of content associated with a lower relevance (e.g., less relevant content can be played back at a higher rate of speed). In some embodiments, the relevance of a portion of content can be more heavily weighted than the complexity of a portion of content. For example, a portion of content that has very low relevance and high complexity may be determined to have a high rate of play back (e.g., irrelevant content can be determined to have a high rate of play back regardless of complexity). Further, a portion of content that has a very high relevance can have a low playback rate or unadjusted play back rate (e.g., the regular or default play back rate of an audio recording) and a low complexity of the portion of content may slightly increase the play back rate and a high complexity of the portion of content may slightly decrease the play back rate.

The disclosed technology can be implemented in a computing system (e.g., an audio playback computing system) that is configured to access data, perform operations on the data (e.g., determine playback rates for portions of content), and generate output including audio content in which the portions of audio are played back at playback rates based on the complexity and relevance of the respective portions. Further, the computing system can leverage one or more machine-learned models that have been configured to generate a variety of output including the complexity of content, the relevance of content, and a playback rate for portions of content. The computing system can be included as part of a system that includes a server computing device that receives content data, performs operations based on the content data and generates output including variable play back rate audio content back to the client computing device. The client computing device can, for example, be configured to play back the audio content based on a user's interaction with a user interface of the client computing device.

The computing system can include specialized hardware and/or software that enable the performance of one or more operations specific to the disclosed technology. The computing system can include one or more application specific integrated circuits that are configured to perform operations accessing (e.g., content data) that includes portions of content (e.g., recorded audio content), determining content complexities and/or content relevancies of the portions of content, determining playback rates for the portions of content, and generating output including indications (e.g., auditory indications) in which the portions of content are played back at the respective playback rates.

The systems, methods, devices, apparatuses, and computer-readable media (e.g., tangible non-transitory computer-readable media) in the disclosed technology can provide a variety of technical effects and benefits including an improvement in the generation of audio content that is played back at an adaptive rate based on the complexity, relevance, and/or semantic structure of the audio content. In particular, the disclosed technology may assist a user (e.g. a user of an audio playback device) in performing technical tasks by means of a continued and/or guided human-machine interaction process in which the rate of audio playback is continuously adjusted based on characteristics of an audio content source. Furthermore, the disclosed technology may provide additional benefits that improve the performance and effectiveness of the systems, devices, and/or services that implement the disclosed technology.

In particular, the disclosed technology can improve the efficiency with which resources are consumed by playing back content in a way that may reduce the overall play back time, thereby reducing energy consumption. For example, the disclosed technology can result in more efficient use of battery power by mobile playback devices that playback audio content. Additionally, the disclosed technology may provide further battery savings by adjusting the play back rate of content at a server computing device and thereby compressing less relevant or complex portions of the content. The smaller sized version of the content can then be sent to a client computing device where the content is played back, thereby reducing network bandwidth utilization when the content is transmitted across a network. By way of example, for an audio file that is encoded at a set bit rate (e.g., one hundred and twenty eight (128) kilobits per second) one or more portions of content that are more less relevant and/or less complex may be transmitted at a higher playback rate that can reduce the total play back time of content and thereby reduce the total amount of storage space that is used to store the transmitted content and the amount of bandwidth that is used to transmit the content. In this way, storage and bandwidth may be preserved without compromising the quality of the encoded audio file.

Further, the disclosed technology can provide an improvement to the overall performance of associated computing systems by continuously updating those computing systems in response to user feedback (e.g., adjusting a playback rate of content) and monitoring of the relevance and/or complexity of content that was acted upon by the user. For example, the play back rates provided by the one or more machine-learned models can be improved based on user feedback that is used as a training input for one or more machine-learned models. This feedback based training input allows the one or more machine-learned models to be continuously updated and more finely tuned to the preferences of each individual user. For example, over time the one or more machine-learned models can be trained and/or updated to better distinguish relevant from irrelevant content based on content data that was previously accessed by a user. User feedback based training can also result in the one or more machine-learned models generating more appropriate playback rates that better match the complexity of the underlying content.

The disclosed technology can also provide a solution to the problem of excessive user interactions with a user interface by reducing the number, type, and/or complexity of burdensome interactions that a user is required to make in order to play content at an appropriate playback rate. This reduction in burdensome interactions (e.g., a user needing to manually adjust the play back rate of content) can, aside from improving the overall ease of using the user interface, also permit the user to engage the user interface more efficiently, thereby conserving computational and battery resources of the associated computing device by reducing the amount of user interaction with the user interface.

As such, the disclosed technology may assist the user of a content playback device or content playback system in more effectively performing a variety of tasks with the specific benefits of reduced resource consumption, more efficient network utilization, an improvement in user interface interactivity, and general improvements to computing performance that result from effective use of machine-learned models. Further, any of the specific benefits provided to users can be used to improve the effectiveness of a wide variety of devices and services including computing devices and/or content services that may provide content (e.g., audio content) at an optimized playback rate. Accordingly, the improvements offered by the disclosed technology can result in tangible benefits to a variety of devices and/or systems including mechanical, electronic, and computing systems associated with adaptively adjusting a playback rate of content.

With reference now to the Figures, example embodiments of the present disclosure will be discussed in further detail.

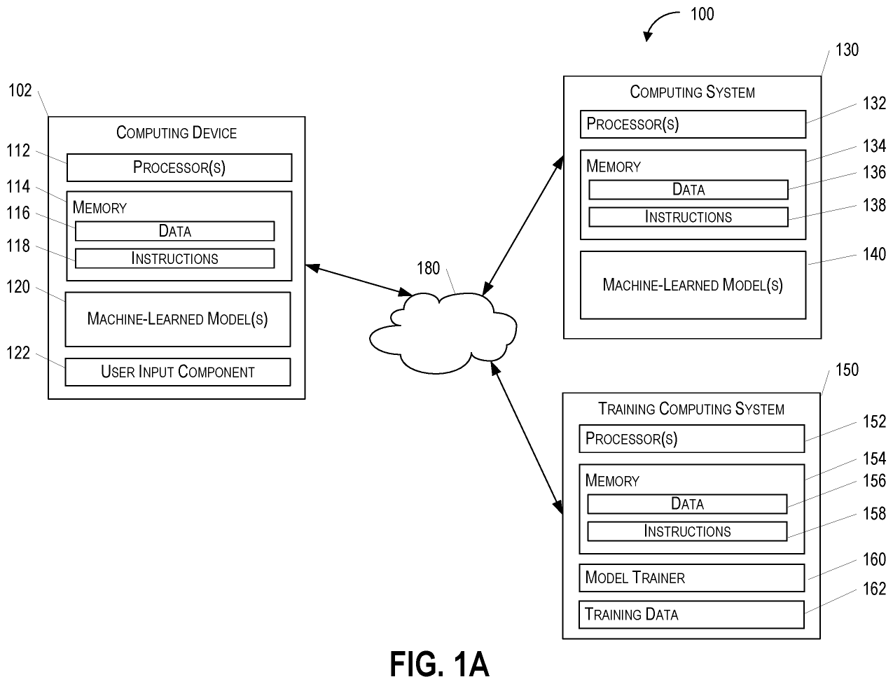

FIG. 1A depicts a block diagram of an example of a computing system that performs operations associated with adaptively adjusting the play back rate of content according to example embodiments of the present disclosure. The system 100 includes a computing device 102, a computing system 130, and a training computing system 150 that are communicatively coupled over a network 180.

The computing device 102 can include or be any type of computing device, including, for example, a personal computing device (e.g., laptop computing device or a desktop computing device), a mobile computing device (e.g., smartphone, or tablet), a gaming console or controller, a wearable computing device (e.g., a smart watch, a smart ring, smart glasses which can include one or more augmented reality features and/or virtual reality features), and/or an embedded computing device.

The computing device 102 includes one or more processors 112 and a memory 114. The one or more processors 112 can be any suitable processing device (e.g., a processor core, a microprocessor, an ASIC, a FPGA, a controller, a microcontroller, etc.) and can be one processor or a plurality of processors that are operatively connected. The memory 114 can include one or more computer-readable mediums (e.g., tangible non-transitory computer-readable media), such as RAM, ROM, EEPROM, EPROM, flash memory devices, magnetic disks, etc., and combinations thereof. The memory 114 can store the data 116 and instructions 118 which are executed by the processor 112 to cause the computing device 102 to perform operations.

In some implementations, the computing device 102 can store or include one or more machine-learned models 120. For example, the one or more machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Examples of one or more machine-learned models 120 are discussed with reference to FIGS. 1A-12.

In some implementations, the one or more machine-learned models 120 can be received from the computing system 130 over network 180, stored in the memory 114, and then used or otherwise implemented by the one or more processors 112. In some implementations, the computing device 102 can implement multiple parallel instances of a single machine-learned model of the one or more machine-learned models 120 (e.g., to perform parallel operations to determine a playback rate for content data that is output in an auditory form).

More particularly, the one or more machine-learned models 120 can be configured and/or trained to access data including content data that includes portions of content (e.g., recorded audio content), determine complexities and/or relevancies of the portions of content, determine playback rates for the portions of content, and generate output including indications (e.g., auditory indications) in which the portions of content are played back at the respective play back rates.

Additionally, or alternatively, one or more machine-learned models 140 can be included in or otherwise stored and implemented by the computing system 130 that communicates with the computing device 102 according to a client-server relationship. For example, the one or more machine-learned models 140 can be implemented by the computing system 130 as a portion of a web service (e.g., a playback rate adjustment service that generates auditory output based on content data). Thus, one or more machine-learned models 120 can be stored and implemented at the computing device 102 and/or one or more machine-learned models 140 can be stored and implemented at the computing system 130.

The computing device 102 can also include one or more of the user input component 122 that is configured to receive user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The computing system 130 includes one or more processors 132 and a memory 134. The one or more processors 132 can be any suitable processing device (e.g., a processor core, a microprocessor, an ASIC, a FPGA, a controller, a microcontroller, etc.) and can be one processor or a plurality of processors that are operatively connected. The memory 134 can include one or more computer-readable mediums (e.g., tangible non-transitory computer-readable media), such as RAM, ROM, EEPROM, EPROM, flash memory devices, magnetic disks, etc., and combinations thereof. The memory 134 can store the data 136 and instructions 138 which are executed by the processor 132 to cause the computing system 130 to perform operations.

In some implementations, the computing system 130 includes or is otherwise implemented by one or more server computing devices. In instances in which the computing system 130 includes plural server computing devices, such server computing devices can operate according to sequential computing architectures, parallel computing architectures, or some combination thereof.

As described above, the computing system 130 can store or otherwise include one or more machine-learned models 140. For example, the one or more machine-learned models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Examples of the one or more machine-learned models 140 are discussed with reference to FIGS. 1A-12.

The computing device 102 and/or the computing system 130 can train the one or more machine-learned models 120 and/or the one or more machine-learned models 140 via interaction with the training computing system 150 that is communicatively coupled over the network 180. The training computing system 150 can be separate from the computing system 130 or can be a portion of the computing system 130.

The training computing system 150 includes one or more processors 152 and a memory 154. The one or more processors 152 can be any suitable processing device (e.g., a processor core, a microprocessor, an ASIC, a FPGA, a controller, a microcontroller, etc.) and can be one processor or a plurality of processors that are operatively connected. The memory 154 can include one or more computer-readable mediums (e.g., tangible non-transitory computer-readable media), such as RAM, ROM, EEPROM, EPROM, flash memory devices, magnetic disks, etc., and combinations thereof. The memory 154 can store the data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the computing device 102 and/or the computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the one or more machine-learned models 120 and/or the one or more machine-learned models 140 based on a set of training data 162. The training data 162 can include, for example, one or more portions of content (e.g., one or more portions of recorded audio) and/or one or more portions of text (e.g., transcriptions of recorded audio). The training data 162 can be tagged with a respective complexity and/or relevance of each portion of content. Further, the training data 162 can include information associated with the semantic structure of the training data 162.

In some implementations, if the user has provided consent, the training examples can be provided by the computing device 102. Thus, in such implementations, the one or more machine-learned models 120 provided to the computing device 102 can be trained by the training computing system 150 on user-specific data received from the computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM hard disk or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can include image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. For example, the text and/or natural language data can include one or more messages and/or one or more portions of audio (e.g., a spoken message) The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic objective output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can include speech data and/or content data that can include one or more portions of content (e.g., one or more portions of recorded audio). The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is of higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output. In some embodiments, the statistical data can include one or more statistics that are based at least in part on the semantic structure of one or more portions of content included in content data. For example, the statistical data can include the frequencies of words, sentence length, complexity values of words, content relevance values of words, and/or statistical information associated with contextual analysis and/or sentiment analysis of words in one or more portions of content including audio content.

In some implementations, the input to the machine-learned model(s) of the present disclosure can include sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the machine-learned model(s) can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data).

In some cases, the input can include visual data and the task can be a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

FIG. 1A depicts a block diagram of an example computing system that performs operations associated with adaptively adjusting a playback rate of content according to example embodiments of the present disclosure. Other computing systems can be used as well. For example, in some implementations, the computing device 102 can include the model trainer 160 and the training data 162. In such implementations, the one or more machine-learned models 120 can be both trained and used locally at the computing device 102. In some of such implementations, the computing device 102 can implement the model trainer 160 to personalize the one or more machine-learned models 120 based on user-specific data.

FIG. 1B depicts a block diagram of an example of a computing device that performs operations associated with adaptively adjusting a playback rate of content according to example embodiments of the present disclosure. The computing device 10 can include a user computing device or a server computing device. Further, one or more portions of the computing device 10 can be included as part of the system 100 that is depicted in FIG. 1A.

The computing device 10 includes a number of applications (e.g., applications 1 through N). Each application contains its own machine learning library and machine-learned model(s). For example, each application can include a machine-learned model. Example applications include an audio playback application, an audio transcription application, a voicemail application, an email application, a dictation application, a virtual keyboard application, and/or a browser application.

As illustrated in FIG. 1B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 1C depicts a block diagram of an example computing device that performs operations associated with adaptively adjusting a playback rate of content according to example embodiments of the present disclosure. The computing device 50 can include a user computing device or a server computing device. Further, one or more portions of the computing device 50 can be included as part of the system 100 that is depicted in FIG. 1A.

The computing device 50 includes a number of applications (e.g., applications 1 through N). Each application is in communication with a central intelligence layer. Example applications include an audio playback application, an audio transcription application, a voicemail application, an email application, a dictation application, a virtual keyboard application, and/or a browser application. In some implementations, each application can communicate with the central intelligence layer (and model(s) stored therein) using an API (e.g., a common API across all applications).

The central intelligence layer includes a number of machine-learned models. For example, as illustrated in FIG. 1C, a respective machine-learned model (e.g., a model) can be provided for each application and managed by the central intelligence layer. In other implementations, two or more applications can share a single machine-learned model. For example, in some implementations, the central intelligence layer can provide a single model (e.g., a single model) for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 1C, the central device data layer can communicate with a number of other components of the computing device, such as, for example, one or more sensors, a context manager, a device state component, and/or additional components. In some implementations, the central device data layer can communicate with each device component using an API (e.g., a private API).

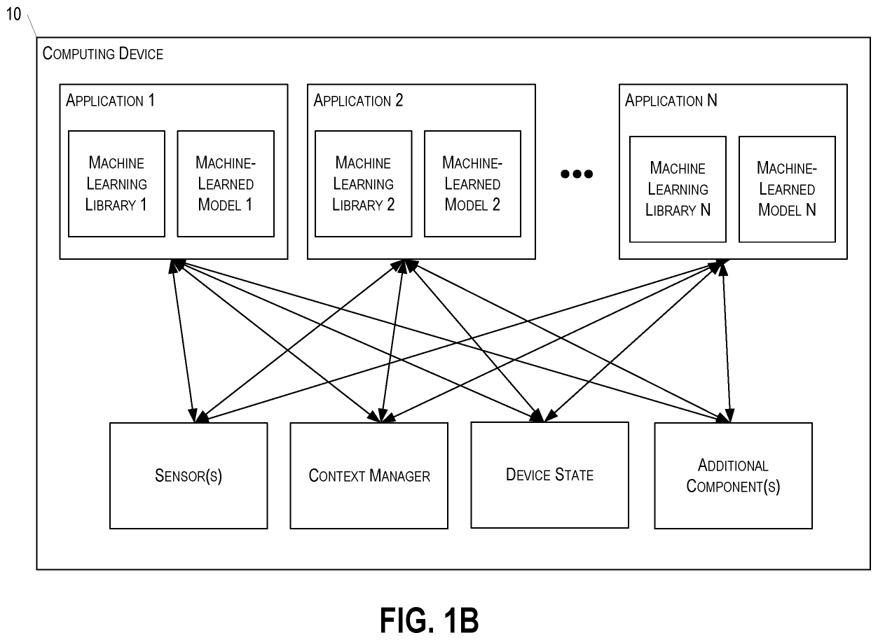

FIG. 2 depicts a block diagram of an example of one or more machine-learned models 200 according to example embodiments of the present disclosure. In some implementations, the one or more machine-learned models 200 are trained to receive a set of input data 204 that can include content data: and, after performing one or more operations on the input data 204, generating output data 206 that can include information associated with one or more relevancies of one or more portions of the content data, one or more complexities of one or more portions of the content data, and/or one or more playback rates of audio output based on the content data. Thus, in some implementations, the one or more machine-learned models 200 can include a content processing machine-learned model 202 that is operable to generate output of a playback rate associated with the complexity, relevance, and semantic structure of content that can be provided to generate audio output to assist a user engaged in a auditory content generation task.

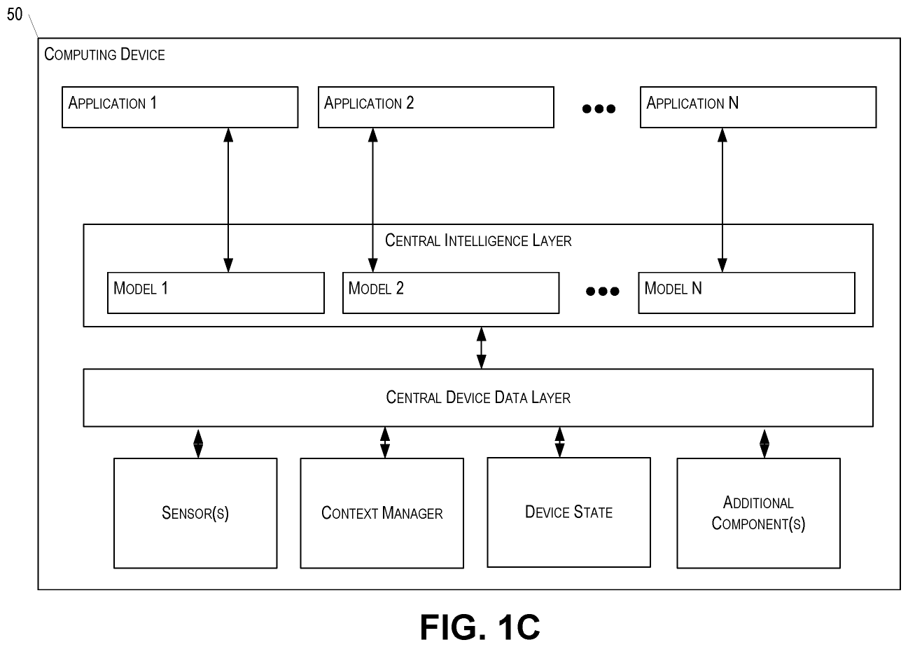

FIG. 3 depicts a diagram of an example computing device according to example embodiments of the present disclosure. A computing device 300 can include one or more attributes and/or capabilities of the computing device 102, the computing system 130, and/or the training computing system 150. Furthermore, the computing device 300 can perform one or more actions and/or operations including the one or more actions and/or operations performed by the computing device 102, the computing system 130, and/or the training computing system 150, which are depicted in FIG. 1A.

As shown in FIG. 3, the computing device 300 can include one or more memory devices 302, content data 304, content complexity profile data 306, content relevance profile data 308, one or more machine-learned models 310, one or more interconnects 312, one or more processors 320, a network interface 322, one or more mass storage devices 324, one or more output devices 326, one or more sensors 328, one or more input devices 330, and/or a location device 332.

The one or more memory devices 302 can store information and/or data (e.g., the content data 304, the content complexity profile data 306, and/or the one or more machine-learned models 310). Further, the one or more memory devices 302 can include one or more computer-readable mediums (e.g., tangible non-transitory computer-readable media), including RAM, ROM, EEPROM, EPROM, flash memory devices, magnetic disks, and combinations thereof. The information and/or data stored by the one or more memory devices 302 can be executed by the one or more processors 320 to cause the computing device 300 to perform operations including operations associated with using the content data 304 to generate output including audio indications played back at determined playback rates.

The content data 304 can include one or more portions of content data (e.g., the data 116, the data 136, and/or the data 156, which are depicted in FIG. 1A) and/or instructions (e.g., the instructions 118, the instructions 138, and/or the instructions 158 which are depicted in FIG. 1A) that are stored in the memory 114, the memory 134, and/or the memory 154, respectively. Furthermore, the content data 304 can include information associated with one or more portions of content that can be stored and/or implemented on the computing device 300. In some embodiments, the content data 304 can be received from one or more computing systems (e.g., the computing system 130 that is depicted in FIG. 1) which can include one or more computing systems that are remote (e.g., in another room, building, part of town, city, or nation) from the computing device 300.

The content complexity profile data 306 can include one or more portions of data (e.g., the data 116, the data 136, and/or the data 156, which are depicted in FIG. 1A) and/or instructions (e.g., the instructions 118, the instructions 138, and/or the instructions 158 which are depicted in FIG. 1A) that are stored in the memory 114, the memory 134, and/or the memory 154, respectively. Furthermore, the content complexity profile data 306 can include information associated with a particular user's comprehension of one or more types of content and can include comprehension values respectively assigned to individual words and/or phrases included in content. In some embodiments, the content complexity profile data 306 can be received from one or more computing systems (e.g., the computing system 130 that is depicted in FIG. 1) which can include one or more computing systems that are remote from the computing device 300.

The content relevance profile data 308 can include one or more portions of data (e.g., the data 116, the data 136, and/or the data 156, which are depicted in FIG. 1A) and/or instructions (e.g., the instructions 118, the instructions 138, and/or the instructions 158 which are depicted in FIG. 1A) that are stored in the memory 114, the memory 134, and/or the memory 154, respectively. Furthermore, the content relevance profile data 308 can include information associated with the relevance of portions of content to a particular user and can include content relevance values respectively assigned to individual words and/or phrases included in content. In some embodiments, the content complexity profile data 306 can be received from one or more computing systems (e.g., the computing system 130 that is depicted in FIG. 1) which can include one or more computing systems that are remote from the computing device 300.

The one or more machine-learned models 310 (e.g., the one or more machine-learned models 120 and/or the one or more machine-learned models 140) can include one or more portions of the data 116, the data 136, and/or the data 156 which are depicted in FIG. 1A and/or instructions (e.g., the instructions 118, the instructions 138, and/or the instructions 158 which are depicted in FIG. 1A) that are stored in the memory 114, the memory 134, and/or the memory 154, respectively. Furthermore, the one or more machine-learned models 310 can include information associated with accessing data including content data that includes portions of content (e.g., recorded audio content), determining complexities and/or relevancies of the portions of content, determining playback rates for the portions of content, and generating output including indications (e.g., auditory indications) in which the portions of content are played back at the respective playback rates. In some embodiments, the one or more machine-learned models 310 can be received from one or more computing systems (e.g., the computing system 130 that is depicted in FIG. 1) which can include one or more computing systems that are remote from the computing device 300.

The one or more interconnects 312 can include one or more interconnects or buses that can be used to send and/or receive one or more signals (e.g., electronic signals) and/or data (e.g., the content data 304, the content complexity profile data 306, the content relevance profile data 308, and/or the one or more machine-learned models 310) between components of the computing device 300, including the one or more memory devices 302, the one or more processors 320, the network interface 322, the one or more mass storage devices 324, the one or more output devices 326, the one or more sensors 328 (e.g., a sensor array), and/or the one or more input devices 330. The one or more interconnects 312 can be arranged or configured in different ways including as parallel or serial connections. Further the one or more interconnects 312 can include one or more internal buses to connect the internal components of the computing device 300; and one or more external buses used to connect the internal components of the computing device 300 to one or more external devices. By way of example, the one or more interconnects 312 can include different interfaces including Industry Standard Architecture (ISA), Extended ISA, Peripheral Components Interconnect (PCI), PCI Express, Serial AT Attachment (SATA), HyperTransport (HT), USB (Universal Serial Bus), Thunderbolt, IEEE 1394 interface (FireWire), and/or other interfaces that can be used to connect components.

The one or more processors 320 can include one or more computer processors that are configured to execute the one or more instructions stored in the one or more memory devices 302. For example, the one or more processors 320 can, for example, include one or more general purpose central processing units (CPUs), application specific integrated circuits (ASICs), and/or one or more graphics processing units (GPUs). Further, the one or more processors 320) can perform one or more actions and/or operations including one or more actions and/or operations associated with the content data 304, the content complexity profile data 306, the content relevance profile data 308, and/or the one or more machine-learned models 310. The one or more processors 320 can include single or multiple core devices including a microprocessor, microcontroller, integrated circuit, and/or a logic device.

The network interface 322 can support network communications. For example, the network interface 322 can support communication via networks including a local area network and/or a wide area network (e.g., the Internet). The one or more mass storage devices 324 (e.g., a hard disk drive and/or a solid state drive) can be used to store data including the content data 304, the content complexity profile data 306, and/or the one or more machine-learned models 310. The one or more output devices 326 can include one or more display devices (e.g., LCD display, OLED display, Mini-LED display, micro LED display, plasma display, and/or CRT display), one or more light sources (e.g., LEDs), one or more loudspeakers, and/or one or more haptic output devices (e.g., one or more devices that are configured to generate vibratory output).

The one or more input devices 330 can include one or more keyboards, one or more touch sensitive devices (e.g., a touch screen display), one or more buttons (e.g., ON/OFF buttons and/or YES/NO buttons), one or more microphones, and/or one or more cameras.

The one or more memory devices 302 and the one or more mass storage devices 324 are illustrated separately, however, the one or more memory devices 302 and the one or more mass storage devices 324 can be regions within the same memory module. The computing device 300 can include one or more additional processors, memory devices, network interfaces, which may be provided separately or on the same chip or board. The one or more memory devices 302 and the one or more mass storage devices 324 can include one or more computer-readable media, including, but not limited to, non-transitory computer-readable media, RAM, ROM, hard drives, flash drives, and/or other memory devices.

The one or more memory devices 302 can store sets of instructions for applications including an operating system that can be associated with various software applications or data. For example, the one or more memory devices 302 can store sets of instructions for applications that can generate output including one or more suggested routes. The one or more memory devices 302 can be used to operate various applications including a mobile operating system developed specifically for mobile devices. As such, the one or more memory devices 302 can store instructions that allow the software applications to access data including content data that is played back in the form of audio output at various playback rates. In other embodiments, the one or more memory devices 302 can be used to operate or execute a general-purpose operating system that operates on both mobile and stationary devices, including for example, smartphones, laptop computing devices, tablet computing devices, and/or desktop computers.

The software applications that can be operated or executed by the computing device 300 can include applications associated with the system 100 shown in FIG. 1A. Further, the software applications that can be operated and/or executed by the computing device 300 can include native applications and/or web-based applications.

The location device 332 can include one or more devices or circuitry for determining the position of the computing device 300. For example, the location device 332 can determine an actual and/or relative position of the computing device 300 by using a satellite navigation positioning system (e.g. a GPS system, a Galileo positioning system, the GLObal Navigation satellite system (GLONASS), the BeiDou Satellite Navigation and Positioning system), an inertial navigation system, a dead reckoning system, based on IP address, by using triangulation and/or proximity to cellular towers or Wi-Fi hotspots, beacons, and the like and/or other suitable techniques for determining position.

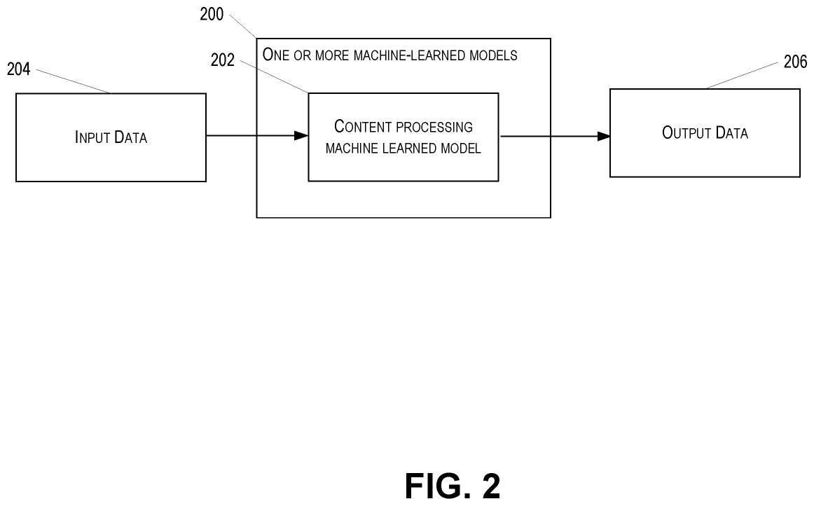

FIG. 4 depicts an example of adaptive adjustment of play back according to example embodiments of the present disclosure. A computing device 400 can include one or more attributes and/or capabilities of the computing device 102, the computing system 130, the training computing system 150, and/or the computing device 300. Furthermore, the computing device 400 can perform one or more actions and/or operations including the one or more actions and/or operations performed by the computing device 102, the computing system 130, the training computing system 150, and/or the computing device 300.

As shown in FIG. 4, the computing device 400 includes a display component 402, an imaging component 404, an audio input component 406, an audio output component 408, an indication 410, an indication 412, an interface element 414, an interface element 416, an interface element 418, and an interface element 420).

The computing device 400 can be configured to perform one or more operations including accessing, processing, sending, receiving, and/or generating data including content data (e.g., content data including recorded audio), any of which can be used to generate output including one or more indications associated with one or more portions of content associated with the content data (e.g., one or more portions of recorded audio). Further, the computing device 400 can receive one or more inputs including one or more interactions by a user with respect to the computing device 400. For example, a user can provide an input to play recorded audio, pause recorded audio, and/or increase/decrease the speed of the playback of recorded audio. In some embodiments, the computing device 400 can be a mobile computing device (e.g., a smartphone and/or a wearable computing device) and can be configured to control another computing device and/or computing system: and/or exchange information and/or data with another computing device and/or computing system.

In some embodiments, the computing device 400 can be included as part of another computing system that may include one or more output devices that can receive signals from the computing device 400 and generate output including aural indications and/or visual indications based at least in part on the output. For example, the computing device 400 can send data including content data to a computing system that can generate output including one or more aural indications (e.g., playing back recorded audio at a playback rate determined by the computing device 400.

In this example, the computing device 400 has accessed content data that includes information associated with an audio recording. The computing device 400 can then perform one or more operations on the content data to determine a rate at which the content can be played back. The rate at which the content is played back can be a variable rate that is adjusted based on the complexity and/or relevance of the content. The computing device 400 can use the content data as an input to one or more machine-learned models that are implemented on the computing device 400 and/or that are implemented on a remote computing device that is able to exchange data and/or information with the computing device 400. The one or more machine-learned models can perform one or more operations on the content data and generate output that includes one or more playback rates (e.g., one or more playback speeds) that can be used when the recorded audio is played back. In some embodiments, the computing device 400 can use one or more pattern recognition techniques to determine the one or more playback rates. For example, the computing device 400 can use one or more pattern generation techniques to determine respective words associated with each portion of content included in the content data. The computing device 400 could then access a dictionary that includes a complexity associated with each word. The computing device 400 could also access a user profile that includes information associated with the relevance of various words to a particular user. The computing device 400 can also use the semantic meaning and arrangement of the words to determine a semantic structure for the portions of content. Using the content complexity, content relevance, and/or the semantic structure associated with the words in the content data, the computing device 400 can determine a playback rate for each portion of the content. The playback rate can be based at least in part on a model that includes a range of play back rates associated with the combination of content complexity, content relevance, and semantic structure. For example, the playback rate can be increased for less complex content, increased for more relevant content, and decreased for more complex semantic structure.

The display component 402 can be configured to receive one or more inputs (e.g., one or more inputs from a user) and/or generate one or more outputs. For example, the display component 402 can be configured to receive inputs including touch inputs associated with initiating playback of content, pausing playback of content, increasing the rate of playback of content, and/or decreasing the rate of playback of content. Further, the display component 402 can be configured to generate one or more outputs including the indication 410. The indication 410 is a transcription of content data (e.g., a transcription generated by the computing device 400 using one or more speech-recognition techniques). The indication 410 is generated by the computing device 400 and can be changed by the computing device 400 based at least in part on the portion of the content data that is being played back by the computing device 400. For example, the indication 410 includes a transcription of approximately twenty (20) sends of the recorded audio stored in the content data. Further, the indication 412 indicates the word that is currently being played back. In this example, the word “SMARTPHONE” is being played back by the computing device 400.

The imaging component 404 can include one or more cameras that can be configured to receive input including one or more images. The one or more images received by the imaging component 404 can be configured to detect the surrounding environment in the field of view of the imaging component 404. The computing device 400 can then use one or more images captured by the imaging component 404 to perform various operations. For example, the computing device 400 can use one or more images captured by the imaging component 404 as an alternative to other input modalities (e.g., a user touching the display component 402). For example, a user can initiate or pause play back of content by gesturing in front of the imaging component 404 (e.g., holding the palm of a hand in front of the imaging component 404 to pause playback).

The audio input component 406 can include one or more microphones that can be configured to receive sound inputs including speech from a user of the computing device 400. For example, a user can initiate playback of content by speaking the word “PLAY” or can pause play back of content by speaking the word “PAUSE.”

In this example, the computing device 400 is implementing an audio playback application that is configured to play back audio content that has been analyzed by the computing device 400. The interface element 414 (“PLAY”) can be used to play back content in the form of audio that is generated by the audio output component 408. The interface element 414 can be used to play content (e.g., an audio recording) based on a user's touch (e.g., tapping or pressing the interface element 414).

The interface element 416 (“PAUSE”) can be used to pause the playback of content that is being generated by the audio output component 408. The interface element 416 can be used to pause the playback of content based on a user's touch (e.g., tapping or pressing the interface element 416).

The interface element 418 (“FASTER”) can be used to increase the rate at which content that is generated by the audio output component 408 is played back. The interface element 418 can be used to increase the play back rate of content based on a user's touch (e.g., tapping or pressing the interface element 418).

The interface element 420 (“SLOWER”) can be used to decrease the rate at which content that is generated by the audio output component 408 is played back. The interface element 420 can be used to decrease the playback rate of content based on a user's touch (e.g., tapping or pressing the interface element 420).

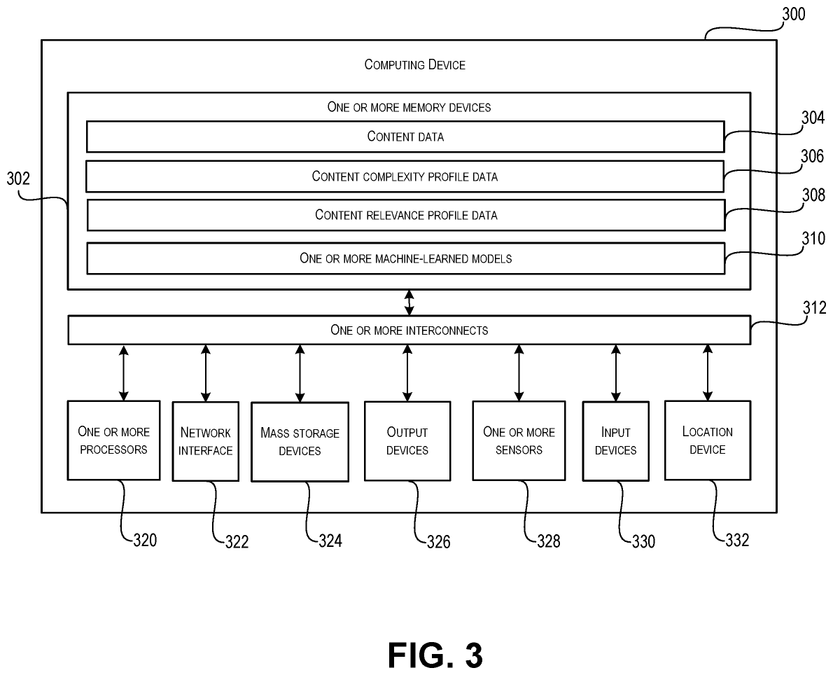

FIG. 5 depicts an example of adaptive adjustment of play back according to example embodiments of the present disclosure. A computing device 500 can include one or more attributes and/or capabilities of the computing device 102, the computing system 130, the training computing system 150, and/or the computing device 300. Furthermore, the computing device 500 can perform one or more actions and/or operations including the one or more actions and/or operations performed by the computing device 102, the computing system 130, the training computing system 150, and/or the computing device 300.

As shown in FIG. 5, the computing device 500 includes a display component 502, an imaging component 504, an audio input component 506, an audio output component 508, an indication 510, an indication 512, an indication 514, an indication 516, an interface element 518, an interface element 520, an interface element 522, and an interface element 524.

The computing device 500 can be configured to perform one or more operations including accessing, processing, sending, receiving, and/or generating data including content data (e.g., content data including recorded audio), any of which can be used to generate output including one or more indications associated with one or more portions of content associated with the content data (e.g., one or more portions of recorded audio). Further, the computing device 500 can receive one or more inputs including one or more interactions by a user with respect to the computing device 500. For example, a user can provide an input to play recorded audio, pause recorded audio, and/or increase/decrease the speed of the play back of recorded audio. In some embodiments, the computing device 500 can be a mobile computing device (e.g., a smartphone and/or a wearable computing device) and can be configured to control another computing device and/or computing system: and/or exchange information and/or data with another computing device and/or computing system.

In some embodiments, the computing device 500 can be included as part of another computing system that may include one or more output devices that can receive signals from the computing device 500 and generate output including aural indications and/or visual indications based at least in part on the output. For example, the computing device 500 can send data including content data to a computing system that can generate output including one or more aural indications (e.g., playing back recorded audio at a playback rate determined by the computing device 500.

In this example, the computing device 500 has accessed content data that includes information associated with an audio recording. The computing device 500 can then perform one or more operations on the content data to determine a rate at which the content can be played back. The rate at which the content is played back can be a variable rate that is adjusted based on the complexity and/or relevance of the content. The computing device 500 can use the content data as an input to one or more machine-learned models that are implemented on the computing device 500 and/or that are implemented on a remote computing device that is able to exchange data and/or information with the computing device 500. The one or more machine-learned models can perform one or more operations on the content data and generate output that includes one or more playback rates (e.g., one or more playback speeds) that can be used when the recorded audio is played back. In some embodiments, the computing device 500 can use one or more pattern recognition techniques to determine the one or more playback rates. For example, the computing device 500 can use one or more pattern generation techniques to determine respective words associated with each portion of content included in the content data. The computing device 500 could then access a dictionary that includes a complexity associated with each word. The computing device 500 could also access a user profile that includes information associated with the relevance of various words to a particular user. The computing device 500 can also use the semantic meaning and arrangement of the words to determine a semantic structure for the portions of content. Using the content complexity, content relevance, and/or the semantic structure associated with the words in the content data, the computing device 500 can determine a playback rate for each portion of the content. The playback rate can be based at least in part on a model that includes a range of playback rates associated with the combination of content complexity, content relevance, and semantic structure. For example, the playback rate can be increased for less complex content, increased for more relevant content, and decreased for more complex semantic structure.

The display component 502 can be configured to receive one or more inputs (e.g., one or more touch inputs from a user) and/or generate one or more outputs. For example, the display component 502 can be configured to generate one or more outputs including the indication 510. The indication 510 is a transcription of content data (e.g., a transcription generated by the computing device 500 using one or more speech-recognition techniques). The indication 510 is generated by the computing device 500 and can be changed by the computing device 500 based at least in part on the portion of the content data that is being played back by the computing device 500. For example, the indication 510 includes a transcription of approximately twenty (20) sends of the recorded audio stored in the content data.

Further, the indication 512 indicates the words “AT A LATITUDE THAT IS ROUGHLY THE SAME AS THAT OF SOME SOUTHERN PORTIONS OF ALASKA. HOWEVER, UNLIKE” which have been determined to be a portion of the content that is of relatively high complexity. The high complexity in the indication 512 partly due to the semantic structure of the words which includes qualifying words “ROUGHLY THE SAME” a reference to another geographic area (“ALASKA”) that is different from the geographic area being discussed (“SAINT PETERSBURG”) and is followed by a further qualifier “HOWEVER, UNLIKE” which indicates that a comparison will be made. Further, indication 512 has high relevance due to the juxtaposition of the subject city of Saint Petersburg with another geographic location, which is relevant in the overall context of discussing the city's unique characteristics. As a result of the combination of high complexity and high relevance associated with the indication 512, the playback rate for the portion of content including the indication 512 may be left at a normal pace or slowed down. In this way, the comprehensibility of a highly complex and relevant portion of content may be maintained or enhanced with a slower playback rate. However, in some situations in which a portion of content has a high complexity and a relatively low relevance (e.g., if the geographical location of Saint Petersburg was not particularly relevant to the content), the play back rate of the portion of content could be increased. Under such circumstances, the amount of time spent playing back a portion of content that is highly complex but not particularly relevant can be reduced with minimal impact on the user's overall comprehension of the content as a whole.

Additionally, the indication 514 specifically includes the words “SAINT PETERSBURG” which represent the a direct reference to the primary subject of the content (e.g., the city of Saint Petersburg) and can further be at least partly determinative of the relevance of the portion of content. Because of the relevance of the indication 514, the playback rate for the portion of content including the indication 514 may be left at a normal pace or slowed down. However, if the words “SAINT PETERSBURG” were not particularly relevant (e.g., the content was about some other city and Saint Petersburg was only mentioned in passing) the playback rate might be increased. The indication 516 indicates the word “IS” which has both low complexity and low relevance, since the word can be removed with little effect on the semantic structure of the sentence represented in the indication 510.

The imaging component 504 can include one or more cameras that can be configured to receive input including one or more images. The one or more images received by the imaging component 504 can be configured to detect the surrounding environment in the field of view of the imaging component 504. The computing device 500 can then use one or more images captured by the imaging component 504 to perform various operations. For example, the computing device 500 can use one or more images captured by the imaging component 504 as an alternative to other input modalities (e.g., a user touching the display component 502). For example, a user can initiate or pause playback of content by gesturing in front of the imaging component 504 (e.g., holding the palm of a hand in front of the imaging component 504 to pause play back).

The audio input component 506 can include one or more microphones that can be configured to receive sound inputs including speech from a user of the computing device 500. For example, a user can initiate play back of content by speaking the word “PLAY” or can pause playback of content by speaking the word “PAUSE.”

In this example, the computing device 500 is implementing an audio play back application that is configured to play back audio content that has been analyzed by the computing device 500. The interface element 518 (“PLAY”) can be used to play back content in the form of audio that is generated by the audio output component 508. The interface element 518 can be used to play content (e.g., an audio recording) based on a user's touch (e.g., tapping or pressing the interface element 518).

The interface element 520 (“PAUSE”) can be used to pause the play back of content that is being generated by the audio output component 508. The interface element 520 can be used to pause the play back of content based on a user's touch (e.g., tapping or pressing the interface element 520).

The interface element 522 (“FASTER”) can be used to increase the rate at which content that is generated by the audio output component 508 is played back. The interface element 522 can be used to increase the playback rate of content based on a user's touch (e.g., tapping or pressing the interface element 522).

The interface element 524 (“SLOWER”) can be used to decrease the rate at which content that is generated by the audio output component 508 is played back. The interface element 524 can be used to decrease the play back rate of content based on a user's touch (e.g., tapping or pressing the interface element 524).

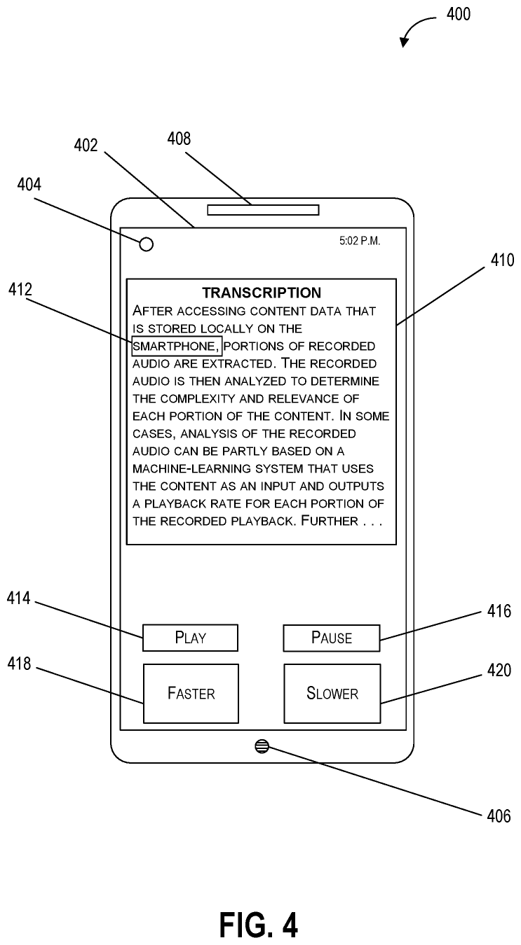

FIG. 6 depicts an example of adaptive adjustment of play back according to example embodiments of the present disclosure. A computing device 600 can include one or more attributes and/or capabilities of the computing device 102, the computing system 130, the training computing system 150, and/or the computing device 300. Furthermore, the computing device 600 can perform one or more actions and/or operations including the one or more actions and/or operations performed by the computing device 102, the computing system 130, the training computing system 150, and/or the computing device 300.

As shown in FIG. 6, the computing device 600 includes a display component 602, an imaging component 604, an audio input component 606, an audio output component 608, an indication 610, an indication 612, an interface element 614, an interface element 616, an interface element 618, and an interface element 620.

The computing device 600 can be configured to perform one or more operations including accessing, processing, sending, receiving, and/or generating data including content data (e.g., content data including recorded audio), any of which can be used to generate output including one or more indications associated with one or more portions of content associated with the content data (e.g., one or more portions of recorded audio). Further, the computing device 600 can receive one or more inputs including one or more interactions by a user with respect to the computing device 600. For example, a user can provide an input to play recorded audio, pause recorded audio, and/or increase/decrease the speed of the play back of recorded audio. In some embodiments, the computing device 600 can be a mobile computing device (e.g., a smartphone and/or a wearable computing device) and can be configured to control another computing device and/or computing system: and/or exchange information and/or data with another computing device and/or computing system.

In some embodiments, the computing device 600 can be included as part of another computing system that may include one or more output devices that can receive signals from the computing device 600 and generate output including aural indications and/or visual indications based at least in part on the output. For example, the computing device 600 can send data including content data to a computing system that can generate output including one or more aural indications (e.g., playing back recorded audio at a playback rate determined by the computing device 600.

In this example, the computing device 600 has accessed content data that includes information associated with an audio recording. The computing device 600 can then perform one or more operations on the content data to determine a rate at which the content can be played back. The rate at which the content is played back can be a variable rate that is adjusted based on the complexity and/or relevance of the content. The computing device 600 can use the content data as an input to one or more machine-learned models that are implemented on the computing device 600 and/or that are implemented on a remote computing device that is able to exchange data and/or information with the computing device 600. The one or more machine-learned models can perform one or more operations on the content data and generate output that includes one or more playback rates (e.g., one or more playback speeds) that can be used when the recorded audio is played back. In some embodiments, the computing device 600 can use one or more pattern recognition techniques to determine the one or more playback rates. For example, the computing device 600 can use one or more pattern generation techniques to determine respective words associated with each portion of content included in the content data. The computing device 600 could then access a dictionary that includes a complexity associated with each word. The computing device 600 could also access a user profile that includes information associated with the relevance of various words to a particular user. The computing device 600 can also use the semantic meaning and arrangement of the words to determine a semantic structure for the portions of content. Using the content complexity, content relevance, and/or the semantic structure associated with the words in the content data, the computing device 600 can determine a play back rate for each portion of the content. The playback rate can be based at least in part on a model that includes a range of playback rates associated with the combination of content complexity, content relevance, and semantic structure. For example, the playback rate can be increased for less complex content, increased for more relevant content, and decreased for more complex semantic structure.

The display component 602 can be configured to receive one or more inputs (e.g., one or more inputs from a user) and/or generate one or more outputs. For example, the display component 602 can be configured to receive inputs including touch inputs associated with initiating playback of content, pausing playback of content, increasing the rate of play back of content, and/or decreasing the rate of playback of content. Further, the display component 602 can be configured to generate one or more outputs including the indication 610. The indication 610 is a transcription of content data (e.g., a transcription generated by the computing device 600 using one or more speech-recognition techniques). The indication 610 is generated by the computing device 600 and can be changed by the computing device 600 based at least in part on the portion of the content data that is being played back by the computing device 600. For example, the indication 610 includes a transcription of approximately twenty (20) sends of the recorded audio stored in the content data. Further, the indication 612 indicates the word that is currently being played back. In this example, the word “SMARTPHONE” is being played back by the computing device 600.

The imaging component 604 can include one or more cameras that can be configured to receive input including one or more images. The one or more images received by the imaging component 604 can be configured to detect the surrounding environment in the field of view of the imaging component 604. The computing device 600 can then use one or more images captured by the imaging component 604 to perform various operations. For example, the computing device 600 can use one or more images captured by the imaging component 604 as an alternative to other input modalities (e.g., a user touching the display component 602). For example, a user can initiate or pause playback of content by gesturing in front of the imaging component 604 (e.g., holding the palm of a hand in front of the imaging component 604 to pause playback).

The audio input component 606 can include one or more microphones that can be configured to receive sound inputs including speech from a user of the computing device 600. For example, a user can initiate playback of content by speaking the word “PLAY” or can pause play back of content by speaking the word “PAUSE.”

In this example, the computing device 600 is implementing an audio playback application that is configured to play back audio content that has been analyzed by the computing device 600. The interface element 614 (“PLAY”) can be used to play back content in the form of audio that is generated by the audio output component 608. The interface element 614 can be used to play content (e.g., an audio recording) based on a user's touch (e.g., tapping or pressing the interface element 614).

The interface element 616 (“PAUSE”) can be used to pause the playback of content that is being generated by the audio output component 608. The interface element 616 can be used to pause the playback of content based on a user's touch (e.g., tapping or pressing the interface element 616). When a user pauses the content, it may be an indication that the user simply wants to stop play back for a while, however, if a user pauses the play back of content multiple times within a predetermined time period, it may be an indication that the content is complex and that the user is pausing due to the complexity. The computing device 600 can then determine that in the future, similar content may be played back at a lower playback rate.

The interface element 618 (“FASTER”) can be used to increase the rate at which content that is generated by the audio output component 608 is played back. The interface element 618 can be used to increase the playback rate of content based on a user's touch (e.g., tapping or pressing the interface element 618). When a user increases the playback rate of content, it may be an indication that the portion of content is not complex or is not relevant (e.g., the user is skipping simple or irrelevant portions of content). The computing device 600 can then determine that in the future, similar content may be played back at a higher playback rate.

The interface element 620 (“SLOWER”) can be used to decrease the rate at which content that is generated by the audio output component 608 is played back. The interface element 620 can be used to decrease the playback rate of content based on a user's touch (e.g., tapping or pressing the interface element 618). When a user decreases the play back rate of content, it may be an indication that the portion of content is complex and/or relevant (e.g., the user is slowing down the rate of play back to focus on certain portions of content). The computing device 600 can then determine that in the future, similar content may be played back at a lower play back rate.

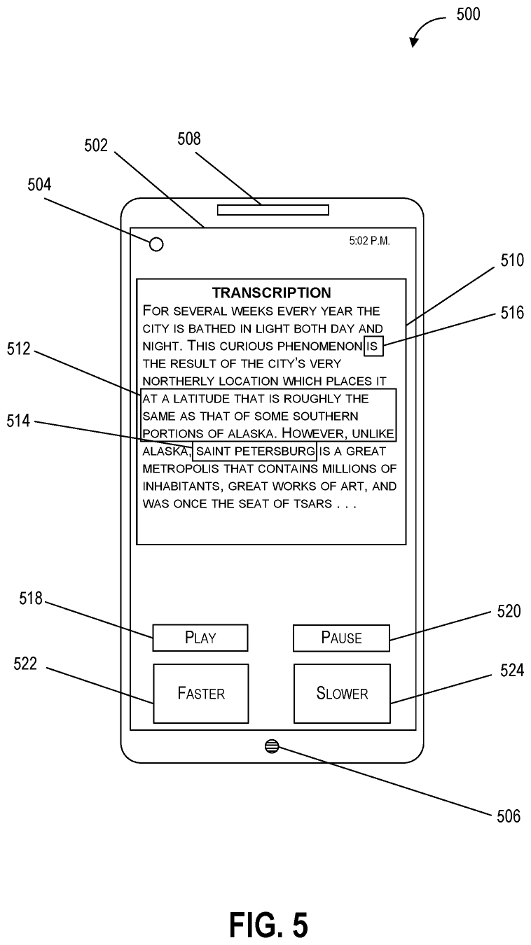

FIG. 7 depicts an example of adaptive adjustment of play back according to example embodiments of the present disclosure. A computing device 700 can include one or more attributes and/or capabilities of the computing device 102, the computing system 130, the training computing system 150, and/or the computing device 300. Furthermore, the computing device 700 can perform one or more actions and/or operations including the one or more actions and/or operations performed by the computing device 102, the computing system 130, the training computing system 150, and/or the computing device 300.

As shown in FIG. 7, the computing device 700 includes a display component 702, an imaging component 704, an audio input component 706, an audio output component 708, an indication 710, an interface element 712, an interface element 714, and an interface element 716.

The computing device 700 can be configured to perform one or more operations including accessing, processing, sending, receiving, and/or generating data including content data (e.g., content data including recorded audio), any of which can be used to generate output including one or more indications associated with one or more portions of content associated with the content data (e.g., one or more portions of recorded audio). Further, the computing device 700 can receive one or more inputs including one or more interactions by a user with respect to the computing device 700. For example, a user can provide an input to play recorded audio, pause recorded audio, and/or increase/decrease the speed of the play back of recorded audio. In some embodiments, the computing device 700 can be a mobile computing device (e.g., a smartphone and/or a wearable computing device) and can be configured to control another computing device and/or computing system: and/or exchange information and/or data with another computing device and/or computing system.

In some embodiments, the computing device 700 can be included as part of another computing system that may include one or more output devices that can receive signals from the computing device 700 and generate output including aural indications and/or visual indications based at least in part on the output. For example, the computing device 700 can send data including content data to a computing system that can generate output including one or more aural indications (e.g., playing back recorded audio at a playback rate determined by the computing device 700.

In this example, the computing device 700 has accessed content data that includes information associated with an audio recording. The computing device 700 can then perform one or more operations on the content data to determine a rate at which the content can be played back. The rate at which the content is played back can be a variable rate that is adjusted based on the complexity and/or relevance of the content. The computing device 700 can use the content data as an input to one or more machine-learned models that are implemented on the computing device 700 and/or that are implemented on a remote computing device that is able to exchange data and/or information with the computing device 700. The one or more machine-learned models can perform one or more operations on the content data and generate output that includes one or more playback rates (e.g., one or more play back speeds) that can be used when the recorded audio is played back. In some embodiments, the computing device 700 can use one or more pattern recognition techniques to determine the one or more playback rates. For example, the computing device 700 can use one or more pattern generation techniques to determine respective words associated with each portion of content included in the content data. The computing device 700 could then access a dictionary that includes a complexity associated with each word. The computing device 700 could also access a user profile that includes information associated with the relevance of various words to a particular user. The computing device 700 can also use the semantic meaning and arrangement of the words to determine a semantic structure for the portions of content. Using the content complexity, content relevance, and/or the semantic structure associated with the words in the content data, the computing device 700 can determine a play back rate for each portion of the content. The play back rate can be based at least in part on a model that includes a range of play back rates associated with the combination of content complexity, content relevance, and semantic structure. For example, the playback rate can be increased for less complex content, increased for more relevant content, and decreased for more complex semantic structure.

The display component 702 can be configured to receive one or more inputs (e.g., one or more inputs from a user) and/or generate one or more outputs. For example, the display component 702 can be configured to receive inputs including touch inputs associated with providing user feedback regarding content that was recently (e.g., in the most recent ten seconds) played. Further, the display component 702 can be configured to generate one or more outputs including the indication 710. The indication 710 is a request for feedback from the user that indicates “PLEASE INDICATE WHETHER THE PLAYBACK RATE OF THE AUDIO CONTENT THAT YOU JUST LISTENED TO WAS APPROPRIATE.”

In this example, the user is presented with the option selecting the interface element 712, the interface element 714, or the interface element 716. The interface element 712 (“THE RATE WAS JUST RIGHT”) can be used by the user to indicate that the one or more playback rates of content that was played back was appropriate. The computing device 700 can save the user's selection and can modify the machine-learned models that determine the play back rates accordingly (e.g., play back similar content at a similar play back rate). The interface element 714 (“THE RATE WAS TOO FAST”) can be used by the user to indicate that the one or more playback rates of content were too fast or too high. The computing device 700 can save the user's selection and can modify the machine-learned models that determine the playback rates accordingly (e.g., in the future, the computing device 700 will play back similar content at a slower playback rate). The interface element 716 (“THE RATE WAS TOO SLOW”) can be used by the user to indicate that the one or more playback rates of content were too slow or too low. The computing device 700 can save the user's selection and can modify the machine-learned models that determine the play back rates accordingly (e.g., in the future, the computing device 700 will play back similar content at a faster play back rate).

The imaging component 704 can include one or more cameras that can be configured to receive input including one or more images. The one or more images received by the imaging component 704 can be configured to detect the surrounding environment in the field of view of the imaging component 704. The computing device 700 can then use one or more images captured by the imaging component 704 to perform various operations. For example, the computing device 700 can use one or more images captured by the imaging component 704 as an alternative to other input modalities (e.g., a user touching the display component 702). For example, a user can initiate or pause playback of content by gesturing in front of the imaging component 704 (e.g., holding the palm of a hand in front of the imaging component 704 to pause playback).

The audio input component 706 can include one or more microphones that can be configured to receive sound inputs including speech from a user of the computing device 700. For example, a user can initiate playback of content by speaking the word “PLAY” or can pause playback of content by speaking the word “PAUSE.”

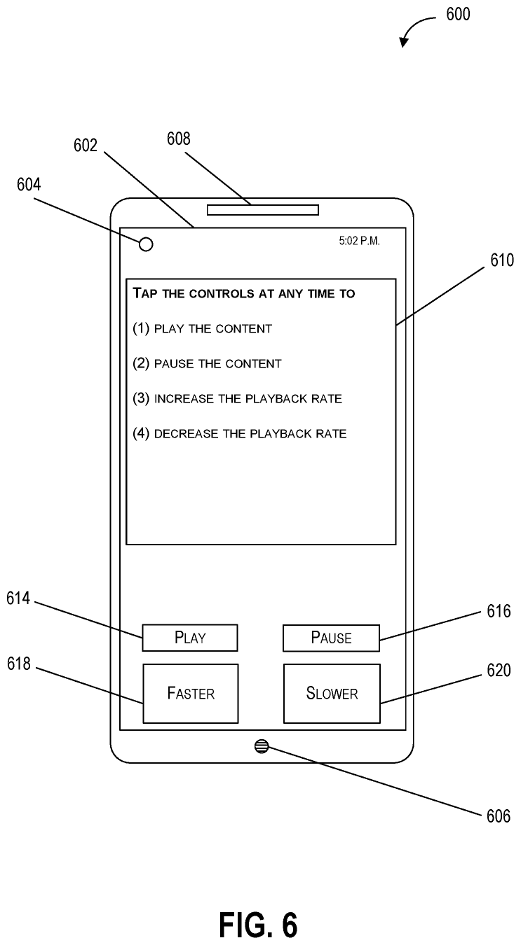

FIG. 8 depicts a flow diagram of adaptive adjustment of play back according to example embodiments of the present disclosure. One or more portions of the method 800 can be executed and/or implemented on one or more computing devices or computing systems including, for example, the computing device 102, the computing system 130, the training computing system 150, and/or the computing device 300. Further, one or more portions of the method 800 can be executed or implemented as an algorithm on the hardware devices or systems disclosed herein. FIG. 8 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 802, the method 800 can include accessing content data. The content data can include one or more portions of content that can be associated with a user. For example, the computing device 102 can access locally stored content data that includes information associated with recorded audio content (e.g., an interview; the news, a podcast, and/or streaming audio). In some embodiments, one or more portions of the content data can be stored remotely (e.g., on the computing system 130) and the computing device 102 can access the one or more portions content based at least in part on one or more requests (e.g., requests associated with an audio playback application that runs on the computing device 102) to play the content.

At 804, the method 800 can include determining one or more content complexities of the one or more portions of content. For example, the computing device 102 can perform one or more operations including using the content data and/or the one or more relevancies of the one or more portions of content as part of an input to one or more machine-learned models that are configured to receive the input, perform one or more operations on the input, and generate an output including the one or more content complexities.

At 806, the method 800 can include determining one or more content relevancies of the one or more portions of content. For example, the computing device 102 can perform one or more operations including using the content data and/or the one or more complexities of the one or more portions of content as part of an input to one or more machine-learned models that are configured to receive the input, perform one or more operations on the input, and generate an output including the one or more content relevancies.

At 808, the method 800 can include determining one or more play back rates. The one or more playback rates can be based at least in part on the one or more content complexities and/or the one or more content relevancies. For example, the computing device 102 can perform one or more operations including using the content data, the one or more complexities, and/or the one or more relevancies as part of an input to one or more machine-learned models that are configured to receive the input, perform one or more operations on the input, and generate an output including the one or more play back rates.

At 810, the method 800 can include generating output. The output can be associated with play back of the one or more portions of content (e.g., the output can include one or more sounds and/or one or more aural indications based at least in part on the one or more portions of content) at the one or more playback rates. For example, the output can be based at least in part on the one or more playback rates (e.g., the play back rate of one or more portions of the output can be based on the one or more play back rates). For example, the output can play each of the one or more portions of content at a respective playback rate. In some embodiments, the output can include one or more indications associated with the one or more portions of content. Further, the one or more indications are based at least in part on the one or more playback rates. The output can be associated with a user interface (e.g., any combination of a graphical user interface that generates the output on a display device and is configured to receive one or more touch inputs from a user and/or a user interface that receives input via one or more microphones and generates output via one or more speakers and/or the display device). For example, the computing device 102 can include an audio output component that is used to generate the one or more indications in an auditory form at the one or more play back rates.

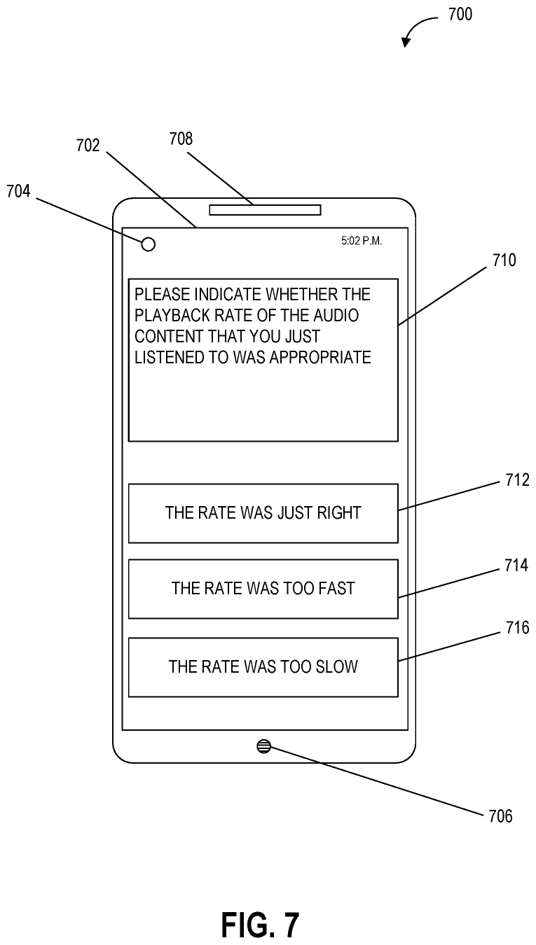

FIG. 9 depicts a flow diagram of adaptive adjustment of playback according to example embodiments of the present disclosure. One or more portions of the method 900 can be executed and/or implemented on one or more computing devices or computing systems including, for example, the computing device 102, the computing system 130, the training computing system 150, and/or the computing device 300. Further, one or more portions of the method 900 can be executed or implemented as an algorithm on the hardware devices or systems disclosed herein. In some embodiments, one or more portions of the method 900 can be performed as part of the method 800 that is depicted in FIG. 8. FIG. 9 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 902, the method 900 can include receiving one or more inputs to a user interface. The one or more inputs can be associated with setting one or more thresholds for the one or more playback rates. For example, the computing device 102 can detect when a user provides one or more touch inputs to one or more interface elements of a tactile user interface displayed on a touch screen display component of the computing device 102. The computing device 102 can then determine whether the one or more touch inputs are associated with setting a minimum playback threshold rate and/or a maximum playback threshold rate for content.

At 904, the method 900 can include determining the one or more playback rates based at least in part on the one or more inputs associated with setting the one or more thresholds for the one or more playback rates. For example, the computing device 102 can then set a ceiling and/or floor on the play back rate.

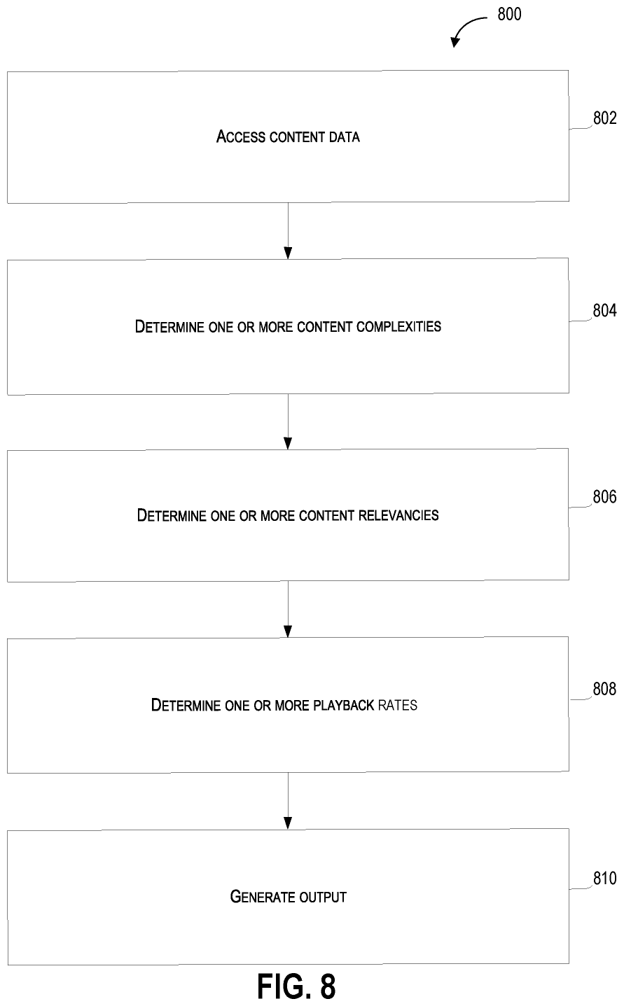

FIG. 10 depicts a flow diagram of adaptive adjustment of play back according to example embodiments of the present disclosure. One or more portions of the method 1000 can be executed and/or implemented on one or more computing devices or computing systems including, for example, the computing device 102, the computing system 130, the training computing system 150, and/or the computing device 300. Further, one or more portions of the method 1000 can be executed or implemented as an algorithm on the hardware devices or systems disclosed herein. In some embodiments, one or more portions of the method 1000 can be performed as part of the method 800 that is depicted in FIG. 8. FIG. 10 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 1002, the method 1000 can include determining one or more words in the one or more portions of content. For example, the computing system 130 can apply one or more natural language processing techniques to determine the one or more words in the one or more portions of content.

At 1004, the method 1000 can include determining a semantic structure of the one or more words. For example, the computing system 130 can determine the semantic structure of the one or more words including words the that are emphasized, words that are repeated, the number of words, the position of words, and the way in which the one or more words in a sentence relate to the one or more words in previous sentences and subsequent sentences. Furthermore, the one or more content complexities can be based at least in part on the semantic structure of the one or more words.

At 1006, the method 1000 can include identifying the one or more portions of content that match the one or more phrases of the content relevance profile. For example, the computing system 130 can identify one or more portions of content that match the one or more phrases of the content relevance profile by performing one or more comparisons of the one or more portions of content to the one or more phrases by using a lookup table that includes the one or more phrases.

At 1008, the method 1000 can include determining at least one of the one or more content relevancies of the one or more portions of content based at least in part on the one or more content relevance values assigned to the one or more phrases that match the one or more portions of content. For example, the computing system 130) can determine that the one or more content relevancies of the one or more portions of content are based at least in part on the total value of the one or more phrases in each of the one or more portions of content.

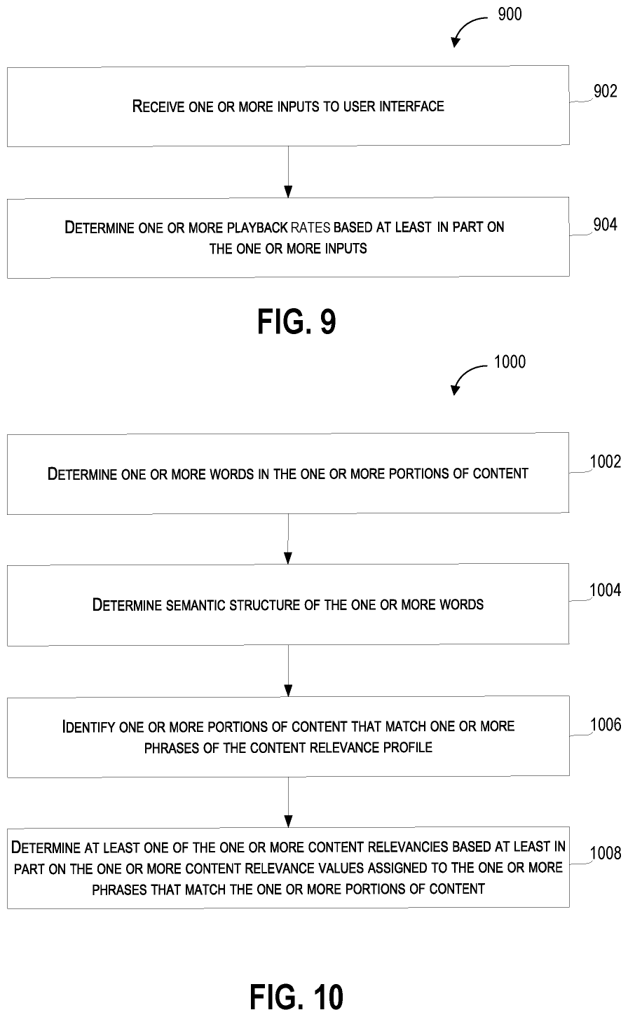

FIG. 11 depicts a flow diagram of adaptive adjustment of play back according to example embodiments of the present disclosure. One or more portions of the method 1100 can be executed and/or implemented on one or more computing devices or computing systems including, for example, the computing device 102, the computing system 130, the training computing system 150, and/or the computing device 300. Further, one or more portions of the method 1100 can be executed or implemented as an algorithm on the hardware devices or systems disclosed herein. In some embodiments, one or more portions of the method 1100 can be performed as part of the method 800 that is depicted in FIG. 8. FIG. 11 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 1102, the method 1100 can include determining the one or more portions of content that are associated with one or more previous portions of content. For example, the computing device 102 can determine a semantic value associated with each of the one or more previous portions of content and compare each of the one or more portions of content to each of the one or more previous portions of content that preceded the portion of content. The computing device 102 can then determine which of the one or more portions of content are associated with one or more previous portions of content.

At 1104, the method 1100 can include adjusting the one or more playback rates of the one or more portions of content that are associated with one or more previous portions of content. Adjusting the one or more playback rates can include increasing the play back rate of the one or more portions of content that are associated with one or more previous portions of content. For example, the computing device 102 can increase the rate of play back of audio content (e.g., a personal name) that has been repeated multiple times within a predetermined period of time (e.g., a name is repeated four (4) times in a one (1) minute period).

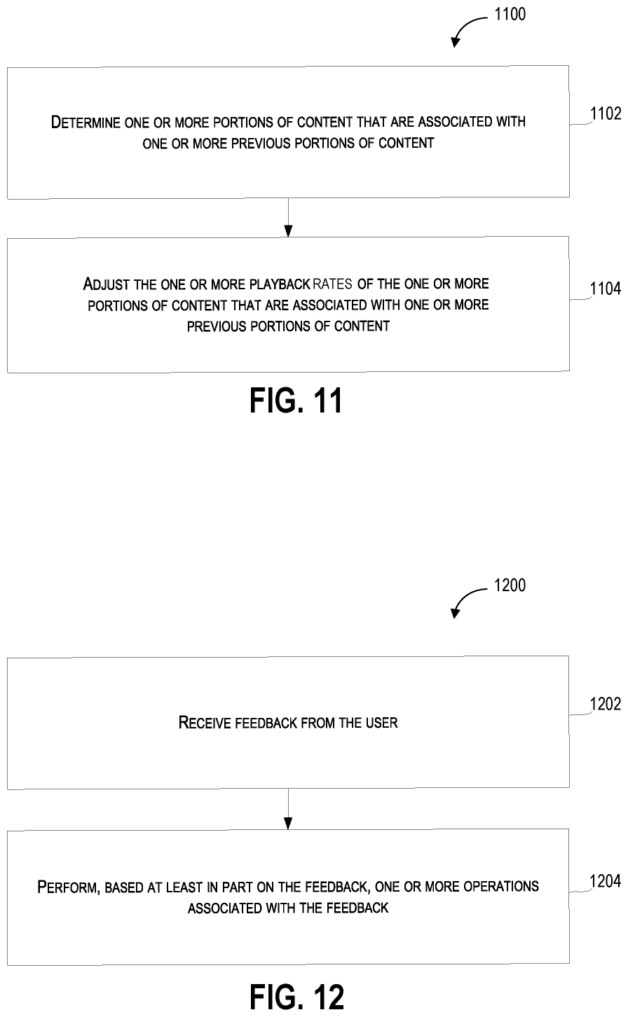

FIG. 12 depicts a flow diagram of adaptive adjustment of play back according to example embodiments of the present disclosure. One or more portions of the method 1200 can be executed and/or implemented on one or more computing devices or computing systems including, for example, the computing device 102, the computing system 130, the training computing system 150, and/or the computing device 300. Further, one or more portions of the method 1200 can be executed or implemented as an algorithm on the hardware devices or systems disclosed herein. In some embodiments, one or more portions of the method 1200 can be performed as part of the method 800 that is depicted in FIG. 8. FIG. 12 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 1202, the method 1200 can include receiving feedback from the user. The feedback from the user can be in response to output generated by the computing system that includes a request for feedback from the user with respect to the one or more playback rates. Further, the feedback can be received via a user interface (e.g., a graphical user interface that is displayed on a display component and receives touch inputs from the user and/or an auditory user interface that uses one or more microphones to receive verbal commands from the user). The feedback from the user can be associated with whether the rate of playback should be increased or decreased. For example, the computing device 102 can generate an interface element asks the user whether the output that was just played back was too fast or too slow and can request that the user indicate their feedback by touching one of three interface elements indicating “TOO FAST,” “TOO SLOW,” and “JUST RIGHT” that are generated on a display component of the computing device 102.

At 1204, the method 1200 can include performing, based at least in part on the feedback, one or more operations associated with the output. For example, in response to the computing device 102 receiving feedback indicating that the user indicated that the audio output was played back at a rate that was too slow, the computing device 102 can modify a user profile to indicate that in the future, similar content (e.g., content with a similar semantic structure) may be played back at a higher rate.

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computer-implemented method of adaptively adjusting a rate of playback, the computer-implemented method comprising:
accessing, by a computing device comprising one or more processors, content data comprising one or more portions of content for a user;
determining, by the computing device, one or more content relevancies of the one or more portions of content;
determining, by the computing device, one or more playback rates, wherein the one or more playback rates are based at least in part on the one or more content relevancies; and
generating, by the computing device, output associated with playback of the one or more portions of content at the one or more playback rates.

2. The computer-implemented method of claim 1, further comprising:
determining, by the computing device, one or more content complexities of the one or more portions of content, wherein the one or more playback rates are based at least in part on the one or more content complexities.

3. The computer-implemented method of claim 2, wherein the one or more playback rates are negatively correlated with the one or more content complexities or the one or more content relevancies.

4. The computer-implemented method of claim 2, wherein the one or more content complexities are based at least in part on a content complexity profile associated with the user, and wherein the content complexity profile is associated with one or more respective user comprehension levels of one or more types of content.

5. The computer-implemented method of claim 2, further comprising:
determining, by the computing device, one or more words in the one or more portions of content; and
determining, by the computing device, a semantic structure of the one or more words, wherein the one or more content complexities are based at least in part on the semantic structure of the one or more words.

6. The computer-implemented method of claim 5, wherein the semantic structure is based at least in part on one or more respective complexities of the one or more words, an arrangement of the one or more words, or a semantic context of each of the one or more words.

7. The computer-implemented method of claim 2, wherein the determination of the one or more content complexities or the one or more content relevancies is based at least in part on use of one or more machine-learned models.

8. The computer-implemented method of claim 7, wherein the one or more machine-learned models are configured to receive input comprising the content data, perform one or more operations on the content data, and generate an output comprising the one or more content complexities or the one or more content relevancies.

9. The computer-implemented method of claim 7, wherein the one or more machine-learned models are configured to determine the one or more content complexities or the one or more content relevancies based at least in part on use of one or more natural language processing techniques, and wherein the one or more natural language processing techniques comprise one or more sentiment analysis techniques or one or more context analysis techniques.

10. The computer-implemented method of claim 1, wherein the one or more content relevancies are based at least in part on a content relevance profile associated with the user, and wherein the content relevance profile is associated with one or more types of content that are relevant to the user.

11. The computer-implemented method of claim 10, wherein the content relevance profile comprises one or more content relevance values respectively assigned to one or more phrases, and further comprising:
identifying, by the computing device, the one or more portions of content that match the one or more phrases of the content relevance profile; and
determining, by the computing device, at least one of the one or more content relevancies of the one or more portions of content based at least in part on the one or more content relevance values assigned to the one or more phrases that match the one or more portions of content.

12. The computer-implemented method of claim 1, further comprising:
determining, by the computing device, the one or more portions of content that are associated with one or more previous portions of content; and
adjusting, by the computing device, the one or more playback rates of the one or more portions of content that are associated with one or more previous portions of content, wherein the adjusting the one or more playback rates comprises increasing the playback rate of the one or more portions of content that are associated with one or more previous portions of content.

13. The computer-implemented method of claim 12, wherein the one or more playback rates are cumulatively adjusted based at least in part on an amount of the one or more previous portions of content.

14. The computer-implemented method of claim 1, further comprising:
receiving, by the computing device, one or more inputs to a user interface, wherein the one or more inputs are associated with setting one or more thresholds for the one or more playback rates; and
determining, by the computing device, the one or more playback rates based at least in part on the one or more inputs associated with setting the one or more thresholds for the one or more playback rates, wherein the one or more thresholds for the one or more playback rates comprise a minimum playback rate or a maximum playback rate.

15. One or more tangible non-transitory computer-readable media storing computer-readable instructions that when executed by one or more processors cause the one or more processors to perform operations, the operations comprising:
accessing content data comprising one or more portions of content for a user;
determining one or more content relevancies of the one or more portions of content;
determining one or more playback rates, wherein the one or more playback rates are based at least in part on the one or more content relevancies; and
generating output associated with playback of the one or more portions of content at the one or more playback rates.

16. The one or more tangible non-transitory computer-readable media of claim 15, wherein the content data comprises audio data associated with auditory content or textual data associated with textual content.

17. The one or more tangible non-transitory computer-readable media of claim 15, wherein the output comprises one or more indications associated with the one or more portions of content, and wherein the one or more indications comprise one or more aural indications or one or more visual indications.

18. A computing system comprising:
one or more processors;
one or more non-transitory computer-readable media storing instructions that when executed by the one or more processors cause the one or more processors to perform operations comprising:
accessing content data comprising one or more portions of content for a user;
determining one or more content complexities of the one or more portions of content;
determining one or more playback rates, wherein the one or more playback rates are based at least in part on the one or more content complexities; and
generating output associated with playback of the one or more portions of content at the one or more playback rates.

19. The computing system of claim 18, wherein the output comprises a request for feedback from the user with respect to the one or more playback rates, and further comprising:
receiving the feedback from the user; and
performing, based at least in part on the feedback, one or more operations associated with the output.

20. The computing system of claim 19, wherein the one or more operations associated with the output comprise adjusting a user profile of the user based at least in part on the feedback, wherein the user profile comprises information associated with the user preferred playback rate, and wherein subsequent output associated with playback of the one or more portions of content is based at least in part on the user profile.
